(19) United States
(12) Patent Application Publication
(10) Pub. No.: US 2020/0233905 A1
(43) Pub. Date: Jul. 23, 2020

(54) Systems and Methods for Data Analysis and Visualization Spanning Multiple Datasets

(71) Applicant: DOMO, INC., American Fork, UT (US)

(72) Inventors: Cameron Williams, Salt Lake City, UT (US); Tyson Christensen, Herriman, UT (US); Jason Hodges, Cottonwood Heights, UT (US)

(21) Appl. No.: 16/650,373

(22) PCT Filed: Sep. 24, 2018
(86) PCT No.: PCT/US18/52504

§ 371 Date: Mar. 24, 2020

Related U.S. Application Data
(60) Provisional application No. 62/562,488, filed on Sep. 24, 2017.

(51) Int. Cl. G06F 16/904; G06F 16/25; G06F 16/22

(52) U.S. Cl. CPC G06F 16/904; G06F 16/221; G06F 16/254

(57) ABSTRACT

An analytics platform provides interfaces for the development, modification, and/or management of operations pertaining to distributed datasets that span multiple data stores. The analytics platform is further configured to limit the extent of the output dataset on which the analysis and/or visualization operations are performed, such that operations for producing, analyzing, and/or visualizing the output dataset can be completed without the need for intervening extract, transform, and load (ETL) processing.

### CROSS REFERENCE TO RELATED APPLICATIONS

This application claims the benefit of U.S. Provisional Patent Application No. 62/562,488, filed Sep. 24, 2017, which is hereby incorporated by reference to the extent such subject matter is not inconsistent with this disclosure.

### TECHNICAL FIELD

The present disclosure generally relates to data processing, and in particular relates to systems and methods for distributed data analysis and visualization spanning multiple data sources.

### BACKGROUND

Information pertaining to an entity is often maintained in a distributed architecture. As used herein, a “distributed architecture” refers to an arrangement in which data pertaining to the entity is distributed physically and/or logically. As used herein, “data” refers to any suitable means for means for representing, recording, encoding, persisting, communicating and/or otherwise managing information. Data may, therefore, refer to electronically encoded information, including, but not limited to: a datum, data unit, a data bit, a set of data bits, a byte, a nibble, a word, a block, a page, a segment, a division, and/or the like. Physical distribution of data refers to maintaining data on physically distributed computing systems (e.g., maintaining data within computing systems deployed at different physical locations). Logical distribution of data refers to distributing data pertaining to an entity across different data stores, each data store having a respective format, encoding, schema, interface, and/or the like. As used herein, “distributed data” refers to data maintained in a distributed architecture (e.g., data that is distributed physically and/or logically).

It may be useful to analyze distributed data together and/or as a single, combined dataset. Conventional approaches for implementing data analytics pertaining to distributed data, however, have significant drawbacks. Conventional means for implementing distributed data analytics typically require intervening data flow processing to, inter alia, extract data from respective data stores, interpret the extracted data, transform the extracted data into a format suitable for specified data analytics operations, combine the extracted, transformed data, and load the resulting ETL data into a designated data store for subsequent processing. These intervening data flows are commonly referred to as Extract, Transform, and Load (ETL) processes.

Conventional approaches to implementing distributed data analytics are complex, inefficient, and inflexible. Conventional distributed data analytics can only be performed after corresponding ETL processes have been completed (and required ETL data have been loaded into storage). The development of the required ETL processes is a highly complex and specialized task that is outside the skillset of a vast majority of users; it is not feasible for typical “consumers” of data analytics (e.g., managers, c-level officers, and/or the like) to engage in the ETL development tasks required to create, update, and/or modify the ETL processes needed in conventional distributed data analytics. Conventional approaches are also inefficient: the ETL processing involved in conventional systems can impose significant latency (e.g., the ETL processing can take a significant amount of time relative to the analytics operations performed on the resulting ETL data), and consume substantial computing resources, particularly when applied to large, complex datasets (e.g., data extraction may consume large amounts of network bandwidth, data transforms may impose significant processing and/or memory overhead, loading ETL data may consume significant storage resources, and so on). Conventional approaches to distributed data analytics are also inflexible. Distributed data analytics operations are typically adapted to operate on ETL data having a specific configuration (e.g., a dataset comprising a particular set of elements/columns). Conventional distributed data analytics may, therefore, be tightly coupled to respective ETL processes; the ETL process configured to obtain ETL data required by a particular distributed analytic is very unlikely to include the elements/columns required by other distributed analytics. Accordingly, implementation of new distributed data analytics may require the development of new ETL processes to produce the ETL data required thereby. Moreover, modifications to existing distributed analytics may require that corresponding modifications to existing ETL processes.

Based on the foregoing, what is needed are systems and methods for efficiently implementing distributed data analytics (e.g., distributed data analytics capable of being implemented at lower latencies and/or while reducing the loads imposed on back-end computing resources). In particular, systems and methods for implementing distributed data analytic operations that do not require intervening data flow processing are needed. Also needed are systems and methods to reduce the complexity of creation, modification, management, and/or implementation of distributed data analytic operations. In particular, systems and methods to provide for the creation, modification, management, and/or implementation of distributed data analytics that do not require the creation, modification, management, and/or implementation of intervening data flow processes (e.g., ETL processes) are needed. Also needed are systems and methods for linking and/or aliasing data stores for use by end users in the creation, modification, management, and/or implementation of distributed data analytics.

### SUMMARY

Disclosed herein are systems and methods for distributed data analytics (e.g., data analytics pertaining to distributed data).

Additional aspects and advantages will be apparent from the following detailed description of various embodiments, which proceeds with reference to the accompanying drawings.

### BRIEF DESCRIPTION OF THE DRAWINGS

FIG. 1 is a schematic block diagram of one embodiment of a system for implementing data analysis and visualization operations that span multiple datasets;

FIG. 2A depicts exemplary source datasets;

FIG. 2B depicts embodiments of data analytics and/or visualization operations;

FIG. 3A depicts embodiments of a distributed data model, as disclosed herein;

FIG. 3B depicts embodiments of interfaces for managing a distributed data model, as disclosed herein;

FIG. 3C depicts embodiments of a distributed data model corresponding to exemplary source datasets, as disclosed herein;

FIG. 3D illustrates embodiments of interfaces for managing a distributed data model, as disclosed herein;

FIGS. 3E-G illustrate embodiments of interfaces for managing distributed datasets spanning one or more linked datasets, as disclosed herein;

FIGS. 3H-J illustrate embodiments of interfaces for managing linked columns of one or more linked datasets, as disclosed herein;

FIG. 4A depicts embodiments of a data analytics and/or visualization component, as disclosed herein;

FIG. 4B depicts embodiments of interfaces for managing and/or implementing data visualizations spanning multiple source datasets, as disclosed herein;

FIG. 5 depicts embodiments of a distributed data analytics and/or visualization engine, as disclosed herein;

FIGS. 6A-B illustrate further embodiments of systems and methods for developing, modifying, and/or implementing data analytics and/or visualizations pertaining to distributed data, as disclosed herein;

FIG. 7 is a schematic block diagram of another embodiment of a system for implementing data analysis and visualization operations that span multiple datasets, as disclosed herein

FIG. 8 is a flow diagram of one embodiment of a method for managing a distributed data model as disclosed herein;

FIG. 9 is a flow diagram of another embodiment of a method for managing a distributed data model as disclosed herein;

FIG. 10 is a flow diagram of one embodiment of a method for managing and/or implementing analytics and/or visualizations pertaining to distributed data; and

FIG. 11 is a flow diagram of one embodiment of a method for implementing analytics and/or visualizations pertaining to distributed data.

### DETAILED DESCRIPTION OF PREFERRED EMBODIMENTS

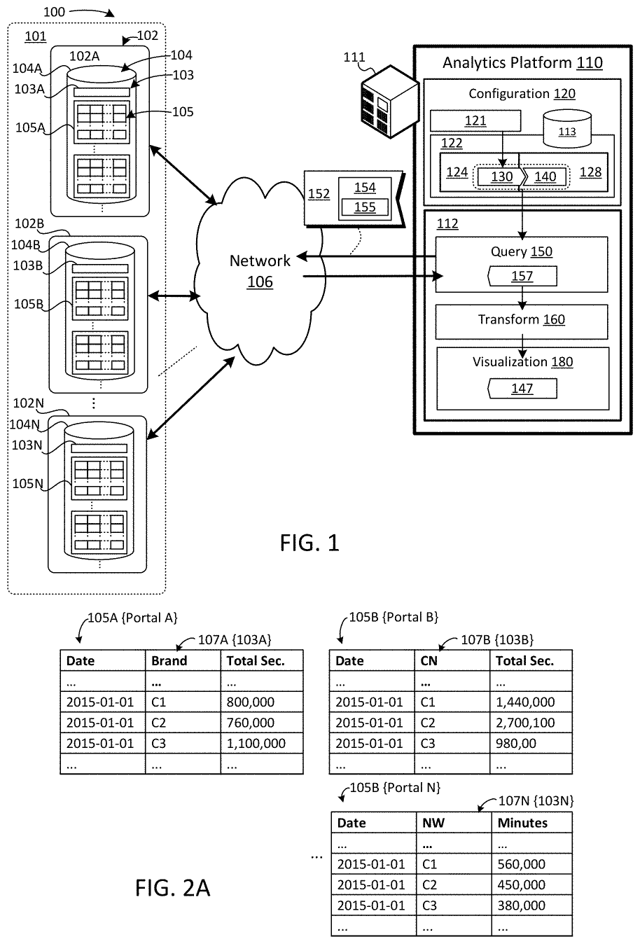

FIG. 1 depicts one embodiment of a system 100 comprising an analytics platform 110 configured to, inter alia, efficiently implement data analytics pertaining to distributed data. FIG. 1 illustrates one non-limiting example of a distributed architecture 101 in which data is distributed across a plurality of data management systems 102, data stores 104, and/or datasets. The distributed architecture 101 (e.g., the computing devices comprising respective DMS 102A-N and/or data stores 104) may be communicatively coupled to a network 106. The network 106 may comprise any means for communicating electronically encoded information (e.g., any suitable means for communicating data, control, and other information, such as queries, requests, responses, data, and/or the like). The network 106 may include, but is not limited to: an Internet Protocol (IP) network (e.g., a Transmission Control Protocol IP network (TCP/IP)), a Local Area Network (LAN), a Wide Area Network (WAN), a Virtual Private Network (VPN), a wireless network (e.g., IEEE 802.11a-n wireless network, Bluetooth® network, a Near-Field Communication (NFC) network, and/or the like), a public switched telephone network (PSTN), a mobile network (e.g., a network configured to implement one or more technical standards or communication methods for mobile data communication, such as Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), or the like), a combination of networks, and/or the like.

As used herein, a “data management system” (DMS) 102 refers to any suitable means for providing storage, accesses, configuration, management, security, and/or authorization services pertaining to data managed thereby, which services may include, but are not limited to: receiving, maintaining, storing, persisting, processing, securing, encrypting, decrypting, signing, authenticating, analyzing, transforming, managing, retrieving, and/or providing access to data. A DMS 102 may include, but is not limited to: a memory device, a memory system, a storage device, a storage system, a non-volatile storage device, a non-volatile storage system, a computing device, a computing system, a data source, a file system, a network-accessible storage service, a network attached storage (NAS) system, a distributed storage and processing system, a distributed file system, a virtualized data management system, a database system, an in-memory database system, a transactional database system, a relational database system, a column-oriented database system, a row-oriented database system, an SQL database system, a NoSQL database system, a NewSQL database system, an XML database system, an Object-Oriented database system, a database management system (DMBS), a relational DMBS, an XML DMBS, an Object-Oriented DMBS, a streaming database system, a directory system, a Lightweight Directory Access Protocol (LDAP) directory system, and/or the like.

A DMS 102 may manage one or more data stores 104. As used herein, a “data store” 104 refers to any suitable means for encoding, formatting, representing, organizing, arranging, and/or managing data. In some embodiments, data maintained within a DMS 102 and/or data store 104 is referred to and/or embodied as a source dataset 105. A dataset, such as a source dataset 105, may include, but is not limited to, one or more of: unstructured data (e.g., data blobs), structured data, files, file metadata, file data, data values, data attributes, data series, data sequences, data structures (e.g., lists, tables, rows, columns, key-value pairs, tuples, revlars, vectors, comma-separated (CSV) data, and/or the like), Structured Query Language (SQL) data (e.g., SQL tables, SQL rows, SQL columns, SQL result sets, and/or the like), eXtensible Markup Language (XML) data, object data, data objects, JavaScript Object Notation (JSON) data, and/or the like.

In some embodiments, DMS 102 and/or data stores 104 managed thereby are configured to encode, format, represent, organize, arrange, and/or manage data in accordance with a schema 103. As used herein, the schema 103 of a source dataset 105 refers to any suitable means for defining characteristics thereof (e.g., means for defining a logical configuration of the source dataset 105) and may include, but is not limited to, one or more of: metadata, file system metadata, a file system schema, a file definition, a data schema, a database schema, a relational database schema, an XML schema, a directory schema, an object schema, a data dictionary, a namespace, a database namespace, a relational database namespace, an XML namespace, an object namespace, and/or the like. The schema 103 of a data store 104 may define, inter alia, elements, tables, columns, rows, fields, relationships, views, indexes, packages, procedures, functions, queues, triggers, types, sequences, materialized views, synonyms, database links, directories, XML schemas, and/or other characteristics of the source dataset 105. The schema 103 of a source dataset 105 may define the elements thereof. As used herein, a “data element” or “element” refers to data having designated semantics, which may include, but are not limited to, one or more of a: definition, identifier, name, label, tag, category, usage, type (e.g., NUMBER, INT, FLOAT, character, string, blob, object, and/or the like), representation, enumerated values, symbol list, and/or the like. An element may refer to one or more of: a column of column-oriented data, a row of row-oriented data, an object, field and/or attribute of object-oriented data, an XML element, field and/or attribute of XML data, a name of name-value data, a key of key-value data, an attribute of attribute-value data, and/or the like. A source dataset 105 may comprise a plurality of entries, each entry comprising one or more fields, each field corresponding to a respective one of the elements of the data store 104. A source dataset 105 may comprise columnar data comprising a plurality of entries (rows), each row comprising a field corresponding to a respective element (column) of the data store 104.

The schema 103 associated with a source dataset 105 may comprise information for use in reading, accessing, extracting, and/or otherwise obtaining data therefrom. In one embodiment, the schema 103 of a DMS 102 may define: the data stores 104 managed by the DMS 102; source datasets 105 managed by respective data stores 104; elements of the source datasets 105; and so on. Extracting data from a source dataset 105 may comprise generating a query comprising parameters corresponding to elements of the source dataset 105 (e.g., specify elements to include in response to the query, indicate elements to exclude, specify filter and/or aggregation criteria pertaining to designated elements, and/or the like). Data acquired in response to such a query may comprise a plurality of entries, each entry comprising one or more fields, each field corresponding to a respective element or column. In another embodiment, the schema 103 of a DMS 102 may: define a set of tables managed by the DMS 102 (each table corresponding to a respective source dataset 105 managed by a respective data store 104); define columns of respective tables; and so on. Extracting data from such a source dataset 105 may comprise generating a query comprising parameters corresponding to respective columns thereof (e.g., specify columns of the source dataset 105 to return in response to the query, indicate columns to exclude, specify filter and/or aggregation criteria pertaining to designated columns, and/or the like). Data acquired in response to such queries may comprise a plurality of entries, each entry comprising one or more fields, each field corresponding to respective columns of the source dataset 105.

In some embodiments, the schema 103 of a source dataset 105 may define, inter alia: the elements and/or columns of the source dataset 105; characteristics of respective elements and/or columns (e.g., names, labels, tags, data types, and/or other characteristics); and/or the like. Extracting data from such a source dataset 105 may comprise generating a query comprising parameters corresponding to elements and/or columns of the source dataset 105 (e.g., specify elements and/or columns to include in response to the query, indicate elements and/or columns to exclude, specify filter and/or aggregation criteria pertaining to designated elements and/or columns, and/or the like). Data received in response to such a query may comprise a plurality of entries, each entry comprising one or more fields, each field corresponding to respective element and/or column.

As disclosed above, distributed analytics refer to analytics pertaining to distributed data. Distributed data refers to data that spans multiple DMS 102, data stores 104, and/or source datasets 105; distributed data may refer to data that is distributed physically (e.g., spans multiple DMS 102) or is distributed logically (e.g., spans multiple source datasets 105 and/or data stores 104 having different schema 103); and/or the like. The distributed architecture 101 of FIG. 1 may comprise distributed data pertaining to one or more entities, organizations, companies, groups, individuals, and/or the like, which may be embodied as source datasets 105 managed by different DMS 102 and/or data stores 104. In the FIG. 1 embodiment, DMS 102A is configured to manage a plurality of data stores 104, including data store 104A comprising source dataset 105A, in accordance with schema 103A; DMS 102B is configured to manage a plurality of data stores 104, including data store 104B comprising source dataset 105B, in accordance with schema 103B, and so on, with DMS 102N managing a plurality of data stores 104, including data store 104N comprising source dataset 105N, in accordance with schema 103N. The source datasets 105A-N may be logically distributed (e.g., may correspond to different respective schema 103A-N); and/or may be physically distributed across a plurality of different DMS 102A-N and/or data stores 104, each DMS 102A-N and/or data store 104A-N comprising one or more computing devices deployed at respective physical locations.

As discussed above, conventional techniques for distributed analytics require ETL processing to address issues related to the physical distribution of the data, logical distribution of the data, data size, and/or the like. In particular, conventional distributed data analytics require ETL processing to load ETL data into storage, which may include, inter alia: extracting data from specified source datasets 105, interpreting the extracted data, transforming the extracted data into a target format (e.g., to conform to a target schema), combining the extracted data, and/or loading the resulting ETL data into storage for subsequent processing. The ETL processing required in conventional systems is complex, inefficient, and inflexible. As discussed above, ETL processes are complex and require personnel with highly specialized skills and experience to properly develop, modify, and maintain. Conventional ETL processing is also inefficient: the intervening ETL processes required to obtain the ETL data required by conventional distributed analytics can take a long time to complete and consume significant computing resources, particularly when applied to large, complex datasets (e.g., source data comprising a large number of rows and/or columns). Conventional distributed data analytics are also inflexible. ETL processes are often closely coupled to corresponding distributed data analytics, such that the ETL processes developed to obtain ETL data comprising the elements/columns required by a first distributed analytic will almost certainly be unsuitable for other distributed analytics (e.g., will not require the elements/columns required by the other distributed analytics). Furthermore, even minor modifications to conventional distributed data analytics are likely to require corresponding modifications to the ETL process used thereby (in order to implement corresponding modifications to the ETL data required by the conventional distributed analytic).

As disclosed above, conventional implementations of distributed analytics require intervening ETL processing to extract, transform, and load ETL data comprising the specific elements/columns required by the distributed analytics. By way of example, a first distributed analytic may be designed to investigate particular characteristics of distributed data, address a particular “business question,” and/or produce a particular Key Performance Indicator (KPI) pertaining to the distributed data (e.g., track average quarterly sales of a particular product based on data managed by a plurality of different organizations in different respective DMS 102 and/or data stores 104). A conventional implementation of the first analytic may, therefore, require development of a first ETL process to store ETL data comprising the elements/columns required by the first distributed analytic (and/or exclude other elements/columns not required thereby). The first ETL process may comprise: extracting data pertaining to sales of the particular product from a plurality of different source datasets 105 (each having a respective schema 103, and being managed by a respective data store 104 and/or DMS 102); transforming the extracted data (e.g., interpreting, transforming, filtering, combining, and/or aggregating the extracted data); and loading the resulting ETL data into persistent storage. The ETL data may be suitable for generating the first distributed data analytic (e.g., average quarterly sales of a particular product), but may not be suitable for use in other data analytics, which may require other data elements not included therein (e.g., sales information pertaining to other products, cost information, and/or the like). Furthermore, modifications to the first distributed data analytics may require corresponding modifications to the first ETL process. For example, a user may request a modification to investigate the profit generated by sales of the particular product, which may require data pertaining to costs associated with the sales and/or distribution of the particular product by each organization. Data required for the modification, however, may not be included in the ETL data loaded by the first ETL process (e.g., the modification may require elements not extracted, transformed, and/or loaded in the first ETL process). Therefore, implementing the modified data analytics may require development of a second ETL process configured to obtain modified ETL data that includes the additional required elements. Development of the second ETL process may be outside of the skillset of the user, and as such, the user may be unable to modify the first distributed analytics and/or develop the second distributed analytics without technical assistance. After obtaining the technical assistance required to develop the second distributed analytics (and corresponding ETL process), the user will not be able to use the second distributed analytics until the second ETL process is complete, which may take a significant amount of time. Subsequent requests for other modifications (or for creation of new distributed analytics) may require the development and implementation of additional, or more complex, ETL processes, further increasing complexity, latency, overhead, and user frustration.

The disclosed analytics platform 110 may be configured to, inter alia, efficiently implement data analytics pertaining to distributed data, without the need for complex, inefficient, inflexible ETL processing. The analytics platform 110 may comprise and/or be embodied on a computing device 111. The computing device 111 may comprise and/or be communicatively coupled to non-transitory storage resources, such as non-transitory storage 113. Although not shown in FIG. 1 to avoid obscuring details of the illustrated embodiments, the computing device 111 may comprise a processor, memory, human-machine interface (HMI) components (e.g., a keyboard, display, trackpad, etc.), a network interface, which may be configured to communicatively couple the computing device 111 to the network 106, and/or the like. In some embodiments, portions of the analytics platform 110 (and/or components thereof) may be embodied as hardware components, such as processing hardware, circuitry, logic circuitry, programmable logic, and/or the like. Portions of the analytics platform 110 may comprise and/or embody components of the computing device 111, peripheral devices, network-attached devices, and/or the like. Alternatively, or in addition, portions of the analytics platform 110 (and/or components thereof) may be embodied as instructions stored within non-transitory storage (e.g., non-transitory storage resources of the computing device 111, such as non-transitory storage 113, a data store 104, a DMS 102, and/or the like). The instructions may configure the computing device 111 to perform operations for efficiently creating, implementing, and/or managing distributed data analytics, as disclosed herein. The instructions may be configured for execution by a processor of the computing device 111, a virtual processing environment, and/or the like (e.g., the instructions may comprise JavaScript configured for execution by a JavaScript engine of a browser application operating on the computing device 111). The instructions may comprise any suitable means for configuring a computing device to perform designated operations including, but not limited to: executable code, intermediate code, byte code, a library, a shared library (e.g., a dynamic link library, a static link library), a module, a code module, an executable module, firmware, configuration data, interpretable code, downloadable code, script code (e.g. JavaScript, Python, Ruby, Perl, and/or the like), a script library, and/or the like. Instructions comprising the analytics platform 110 may be communicated to the computing device 111 via the network 106. The instructions may be communicated from any suitable source including, but not limited to: a server computing device, a web service, a DMS 102A-N, and/or the like. The instructions of the analytics platform 110 may be cached and/or stored within volatile and/or virtual memory of the computing device 111.

The disclosed analytics platform 110 may be configured to provide for the efficient creation, implementation, and management of distributed data analytics. The analytics platform 110 may be further configured to reduce the complexity involved in the development and/or modification of distributed analytics, which may enable such tasks to be performed by end users, without the need for specialized technical assistance. The disclosed analytics platform 110 may be configured to generate user interfaces configured to enable users to access, implement, create, modify, and/or manage distributed data, analytics pertaining to distributed data (e.g., visualizations pertaining to distributed data), and/or the like. The analytics platform 110 may extend the functionality of the computing device 111, enabling the computing device 111 to implement distributed analytics more efficiently, without the complexity, overhead, and/or inflexibility of the data flow and/or ETL processing involved in conventional distributed analytics. Furthermore, the disclosed analytics platform 110 may extend the functionality of the computing system 111 to provide for creation, modification, and/or management of distributed data analytics by end users who may not have the specialized training, experience, and/or expertise required for development of the complex ETL processes of conventional systems.

The analytics platform 110 may be configured to manage and/or implement data analytics pertaining to distributed data (e.g., data that spans a plurality of source datasets 105, data stores 104 and/or DMS 102). In the FIG. 1 embodiment, the analytics platform 110 is configured to implement analytics pertaining data distributed between a plurality of source datasets 105A-N. The source datasets 105A-N may comprise related information (e.g., information pertaining to a particular entity, joint operations between the entity and one or more third-parties, and/or the like).

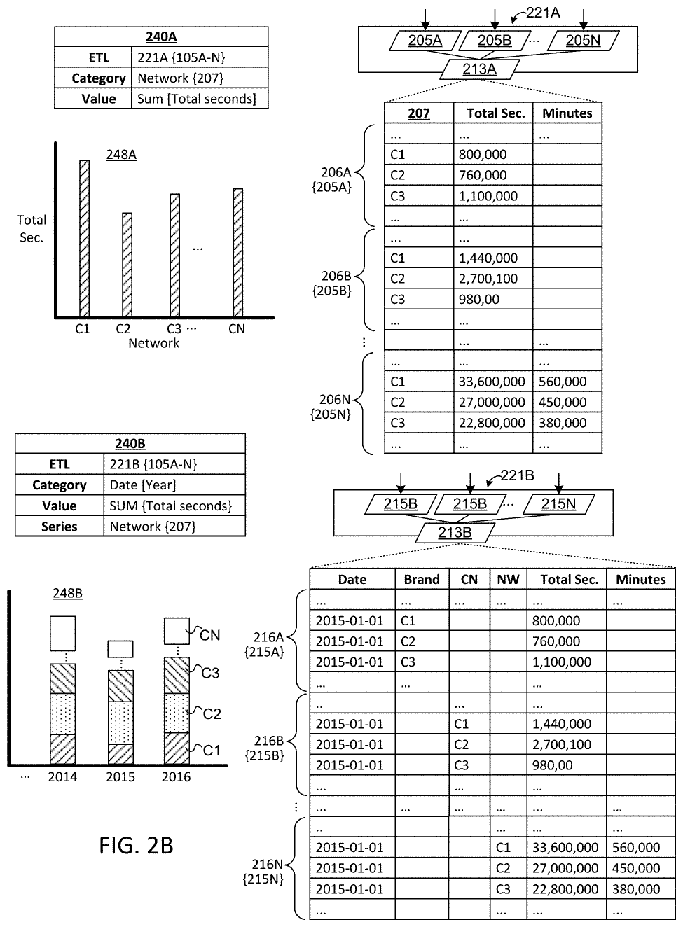

FIG. 2A depicts exemplary source datasets 105A-N. By way of non-limiting example, the source datasets 105A-N may comprise data pertaining to the delivery of programming content of various networks through a plurality of different portal services (e.g., portals A-N). Data pertaining to such content delivery through each portal A-N may be maintained in different respective source datasets 105A-N (managed by different respective DMS 102A-N and/or data stores 104A-N, as illustrated in FIG. 1). Alternatively, two or more of the source datasets 105A-N may be managed by a same data store 104 and/or two or more of the data stores 104A-N may be managed by a same DMS 102.

As illustrated in FIG. 2A, each source dataset 105A-N may comprise column-oriented data organized in accordance with a respective schema 103A-N: the source dataset 105A may comprise columns 107A (per schema 103A), defining respective entries and/or rows indicating the total seconds of programming content delivered through “Portal A” (by use of “Date,” “Brand,” “Total seconds,” and/or other data columns); the source dataset 105B may comprise columns 107B (per schema 103B), defining respective entries and/or rows indicating the total seconds of programming content delivered through “Portal B” on respective dates (by use of “Date,” “CN,” “Total seconds” and/or other data columns); and so on, with the source dataset 105N comprising columns 107N (per schema 103N), defining respective entries and/or rows indicating the minutes of programming content delivered through “Portal N” (by use of “Date,” “NW,” “Minutes,” and/or other data columns). The source datasets 105A-N may comprise additional columns, which are not depicted in FIG. 2A to avoid obscuring details of the illustrated embodiments (e.g., columns comprising data pertaining to costs associated with content delivery, customer information, service-specific information, and/or the like). Moreover, although FIG. 2A illustrates exemplary column-oriented source datasets 105A-N, the disclosure is not limited in this regard and could be adapted for use datasets of any suitable type and/or having any suitable schema.

FIG. 2B depicts exemplary embodiments of conventional distributed analytics spanning the plurality of source datasets 105A-N. First distributed data analytics 240A may correspond to a sum of “Total seconds” of programming content of respective networks delivered through the plurality of portals (as maintained within respective source datasets 105A-N). The first distributed data analytics 240A may comprise a first visualization 248A, which may comprise a visualization of the “Total seconds” of programming content by “Network.” The first distributed data analytics 240A may require a first ETL process 221A to extract, transform, and load the data required thereby (first ETL data 213A). The first ETL process 221A may comprise, inter alia, extracting datasets 205A-N from respective source datasets 105A-N, transforming the extracted datasets 205A-N to produce transformed datasets 206A-N, combining the transformed datasets 206A-N (e.g., “stacking” the transformed datasets 206A-N) to produce the elements/columns required by the first distributed data analytics 240A, and loading the resulting first ETL data 213A into a storage for subsequent use. The first ETL process 221A may comprise normalizing and/or combining the extracted datasets 205A-N, such that the minute and/or total seconds columns thereof can be properly queried, aggregated, analyzed, and/or visualized as a single dataset. The first ETL process 221A may comprise, inter alia, normalizing the “Brand,” “CN,” and “NW” columns of the extracted datasets 206A-N to a common “Network” column 207, calculating a “Total seconds” column from the “Minutes” column of the extracted dataset 206N, and/or the like.

As disclosed above, the source datasets 105A-N may comprise other elements and/or columns in addition to those depicted in FIG. 1 (e.g., may comprise columns comprising cost information, regional information, and/or the like). The source datasets 105A-N may comprise millions, or even billions, of rows. Moreover, since the first ETL process 221A must be completed before the first distributed data analytics 240A and/or visualizations 248A can be used, it may not be possible to limit the range and/or extent of data extracted by the first ETL process 221A (it may not be possible to determine which ranges and/or extents of the underlying source datasets 105A-N will be required when the first distributed data analytics 240A and/or visualization 248A are subsequently accessed by end users). The first ETL process 221A may, therefore, involve the extraction, transformation, and/or storage of large amounts of data and, as such, may be resource intensive and time consuming (take numerous days to complete). The resource overhead and latency of the first ETL process 221A may correspond to the amount, size, and/or complexity of the datasets 205A-N extracted from each source dataset 105A-N. Extracting elements/columns not required by the first distributed data analytics 240A, and/or including such data in the first ETL data 213A may, therefore, unnecessarily increase the overhead, complexity, and/or latency of the first ETL process 221A (e.g., increase the network resources required to extract data from the data stores 104A-N, increase the memory, storage, and/or processing resources required to transform the extracted datasets 205A-N, and increase the storage resources required to store the first ETL data 213A, resulting in corresponding increases to the time required to complete the first ETL process 221A). It may not be feasible, or even possible, for the first ETL process 221A to extract, transform, and/or load elements/columns other than those required in the first distributed data analytics 240A.

The overhead, complexity, and/or latency considerations described above may require conventional distributed data analytics to be closely tied to corresponding ETL processes (e.g., the first ETL process 221A to be closely coupled to the first ETL process 221A, such that the first ETL process 221A extracts only the particular elements/columns required by the first distributed data analytics 240A, and excludes other elements/columns of the data stores 104A-N). This close-coupling may result in inflexibility, which may: render the first ETL process 221A unsuitable for use in other distributed analytics; limit and/or complicate modifications to the first distributed data analytics 240A; and/or the like. Conventional distributed analytics, such as the first distributed data analytics 240A, may be limited to “drill paths” that require specified elements/columns (e.g., drill paths pertaining to data elements/columns included in the first ETL data 213A acquired by the first ETL process 221A). Modifications that would deviate from these pre-determined drill paths (e.g., involve elements/columns not included in the first ETL data 213A) may, therefore, require the development of a new distributed analytics and/or corresponding ETL process to obtain the additional elements/columns required by such modifications. By way of non-limiting example, a user of the first distributed data analytics 240A may request modifications to investigate other characteristics of the distributed data (e.g., investigate different “business questions” and/or KPI), such as the yearly average and/or sum of network content delivered by the service providers. Due to the overhead, complexity, and/or latency considerations discussed above, it may not be possible to modify the first distributed data analytics 240A and/or first ETL process 221A to support the requested modifications. In particular, the first ETL data 213A may not include the elements/columns required by the required modifications (e.g., may not comprise date elements/columns required to calculate yearly averages and/or sums). In a conventional system, implementation of the requested modifications may require development of a second distributed data analytics 240B and corresponding second ETL process 221B to acquire second ETL data 213B that comprises the elements/columns required by the second distributed data analytics 240B (e.g., required date elements/columns).

As illustrated in FIG. 2B, the second ETL process 221B may be configured to extract datasets 215A-N from respective data stores 104A-N (each dataset 215A-N comprising entries corresponding to a respective set of columns 107A-N), transform the extracted datasets 215A-N (e.g., normalize, stack, and/or add columns to the extracted datasets 215A-N), and load the resulting second ETL data 213B comprising transformed datasets 216A-N into storage. The second ETL process 221B may comprise populating a new “total seconds” column of dataset 213N with total seconds values derived from the “minutes” column thereof. Although not shown in FIG. 2B, the second ETL process 221B may further comprise converting the brand, CN, and/or NW columns of datasets 225A-N into a common Network column 207, as disclosed above. As discussed above, the development and/or modification of ETL processes may be outside the skillset of the user and, as such, the user may not be capable of developing the second distributed data analytics 240B (and/or the second ETL process 221B) without the assistance of specially trained personnel. After obtaining the technical assistance required to develop the second ETL process 221B, however, the user may have to wait for the second ETL process 221B to complete before results of the second distributed data analytics 240B can be generated. The source datasets 105A-N (and corresponding extracted datasets 215A-N) may comprise a large number of entries/rows. Moreover, since the second ETL process 221B must be completed before the second distributed data analytics 240B and/or visualizations 248B can be accessed by end users, it may not be possible to limit the range and/or extent of data extracted by the second ETL process 221B (it may not be possible to determine which date ranges will be required by end users when the second distributed data analytics 240B and/or visualizations 248B are eventually accessed thereby). Accordingly, the second ETL process 221B may take considerable time to complete, further delaying implementation and increasing user frustration.

Referring back to FIG. 1, the analytics platform 110 may enable users to develop distributed analytics that do not require intervening ETL processing. The analytics platform 110 may be further configured to improve the efficiency of distributed analytics by, inter alia, implementing distributed analytics without performing the complexity, overhead, and/or latency of conventional implementations (e.g., without the need for intervening ETL processing). In some embodiments, the analytics platform 110 is configured to reduce the complexity of data model distributed analytics and/or improve the implementation thereof, by use of a distributed data model 130. As used herein, a distributed data model 130 may comprise any suitable information pertaining to the distributed architecture 101 and/or data maintained therein. The distributed data model 130 may comprise information pertaining to respective DMS 102, data stores 104, source datasets 105, and/or the like. As disclosed in further detail herein, the distributed data model 130 may further comprise and/or define one or more distributed datasets that span multiple DMS 102, data stores 104, and/or source datasets 105. The distributed data model 130 may be maintained by a configuration manager 120 of the analytics platform 110. The configuration manager 120 may be configured to store, persist, cache, and/or record portions of the distributed data model 130 in non-transitory storage.

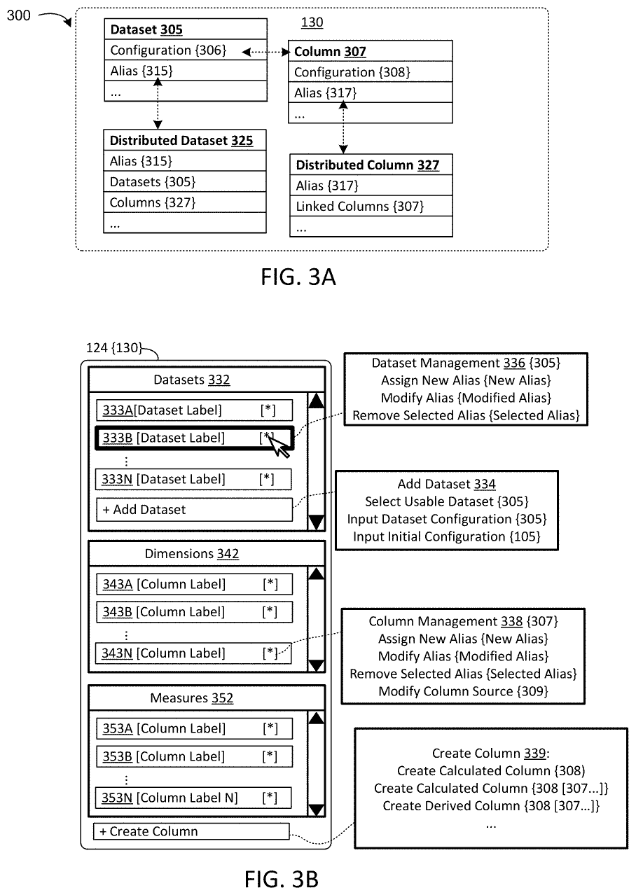

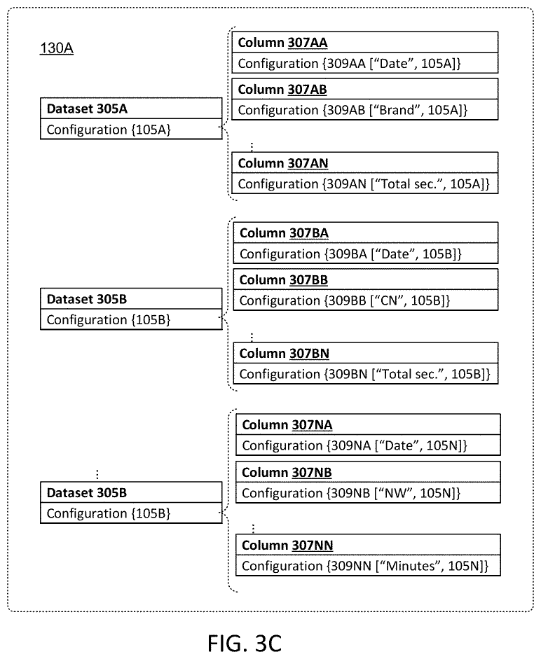

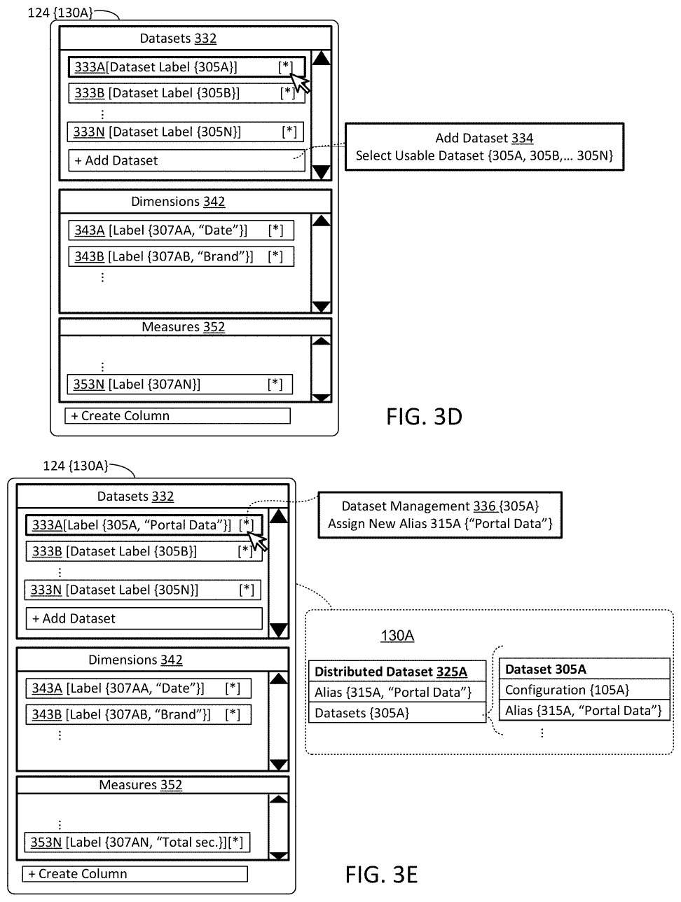

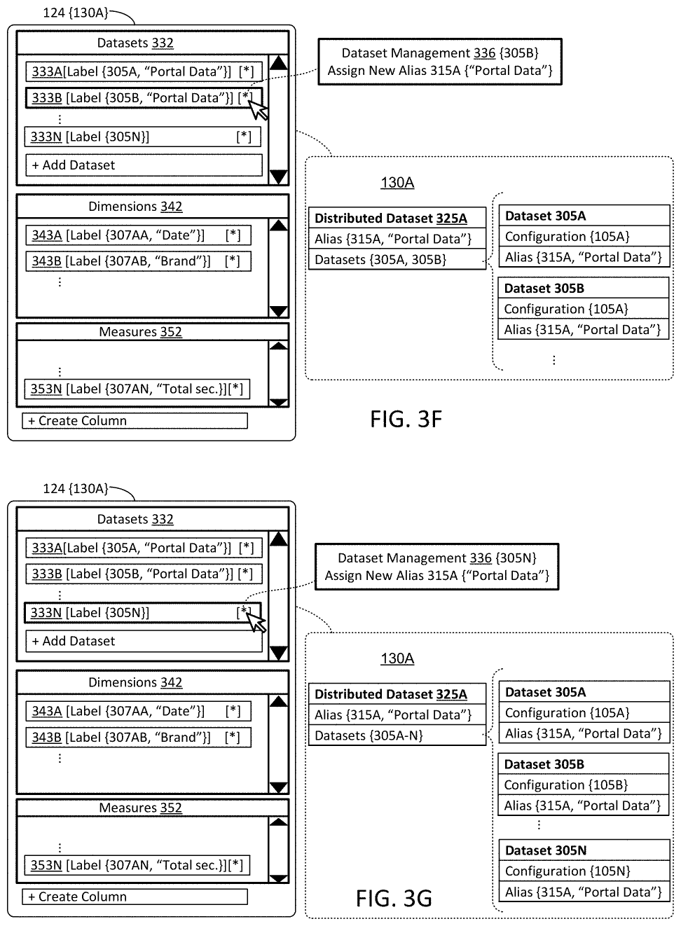

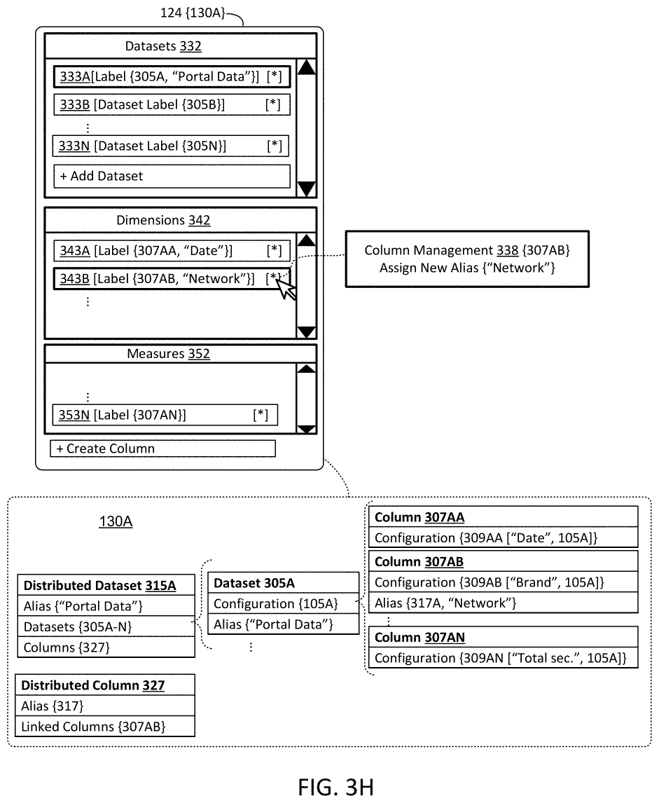

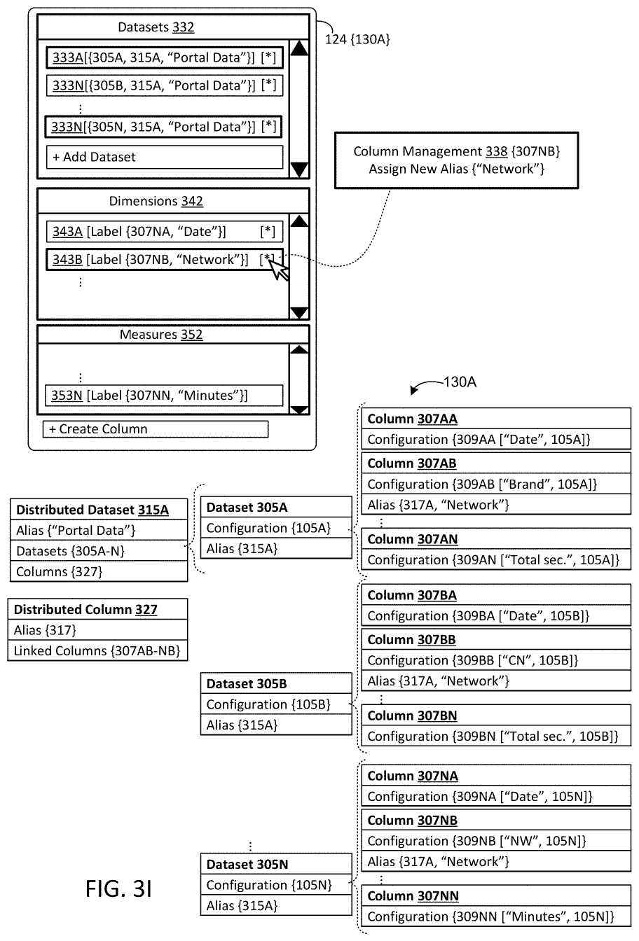

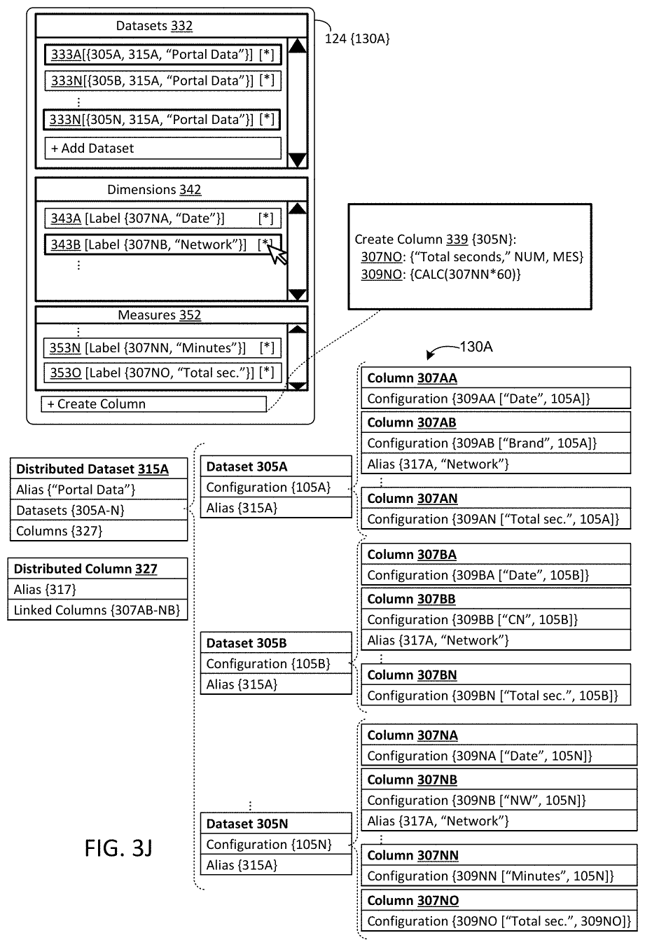

FIG. 3A is a schematic block diagram 300 depicting one embodiment of a distributed data model 130. As disclosed in further detail herein, the distributed data model 130 of the FIG. 3 embodiments may correspond to column-oriented data storage (e.g., DMS 102, data stores 104, and/or source datasets 105 comprising columnar data). The disclosure is not limited in this regard, however, and could be adapted for use with any suitable DMS 102, data stores 104, and/or source datasets 105 having any suitable data representation, encoding, formatting, organization, arrangement, schema 103, and/or the like.

The distributed data model 130 may comprise usable datasets (datasets 305). As used herein, a “usable dataset” refers to a dataset capable of being used within the analytics platform 110. A usable dataset may correspond to a dataset that is accessible to the analytics platform 110 and/or a user thereof. In the FIG. 1 embodiment, source datasets 105A-N, and/or other source datasets 105 managed by respective DMS 102A-N and/or data stores 104A-N, may comprise usable datasets. A dataset 305 of the distributed data model 130 may comprise a configuration, which may correspond to a configuration of a source dataset 105 (and/or reference another dataset 305). The configuration of a dataset 305 may comprise a source configuration 306 which, as disclosed in further detail herein, may comprise means for configuring the analytics platform 110 to access, read, query, and/or otherwise obtain data corresponding to the dataset 305.

The configuration of a dataset 305 may further define the usable columns thereof. As used herein, a “usable column” refers to a column of a dataset 305 that is usable and/or accessible within the analytics platform 110. The distributed data model 130 may provide for defining the usable columns of a dataset 307 by use of one or more columns objects (columns 307). In the distributed data model 130 each usable column of a dataset 305 may be represented by a respective column 307. A column 307 may comprise a configuration, which may comprise any suitable information pertaining thereto, such as a column name, type, classification, and/or the like. The configuration of a column 307 may define a type of the column. The configuration of a column 307 may indicate a data type of the column (e.g., character, string, date, enumerated values, symbol values, number, INT, FLOAT, blog, and/or the like). The configuration of a column 307 may further indicate a classification of the column 307. As disclosed in further detail herein, the classification of a column 307 may determine ways in which the column 307 may be used within the analytics platform 110. In some embodiments, the columns 307 may be classified as one of a dimension (DIM) column 307, a measure (MES) column 307, and/or the like. As used herein, a “dimension column” 307 refers to a column 307 that comprises qualitative data suitable for designated types of operations (e.g., categorization operations, sequencing operations, aggregation operations, and/or the like). A dimension column 307 may refer to a column 307 having a particular data type (e.g., character, string, date, enumerated values, symbol values, and/or the like). Dimension columns 307 may be used as, inter alia, category, dimension, non-aggregated series columns, and/or the like. By way of non-limiting example, a dimension column 307 may be used to define the x-axis of a data visualization (e.g., may be used as the dimension and/or category axis of the visualization). As used herein, a “measure column” 307 refers to a column 307 that comprises qualitative data suitable for designated types of operations (e.g., categorization operations, sequencing operations, aggregation operations, and/or the like). A dimension column 307 may refer to a column 307 having a particular data type (e.g., character, string, date, enumerated values, symbol values, and/or the like). Dimension columns 307 may be used as, inter alia, category columns, dimension columns, non-aggregated series columns, and/or the like. By way of non-limiting example, a measure column 307 may be used to define the y-axis of a data visualization (e.g., may be used as the value and/or measure axis of the visualization).

The configuration of a column 307 may further comprise a source configuration 308. As disclosed in further detail herein, the source configuration 308 may comprise means for configuring the analytics platform 110 to access, read, query, and/or otherwise obtain data corresponding to the column 307 (in conjunction with the source configuration 306 of the dataset 305 thereof).

As disclosed above, the source configuration 306 of a dataset may comprise means for configuring the analytics platform 110 to access, read, query, search, and/or otherwise obtain data corresponding to the dataset 305 (and/or one or more columns 307 thereof). The source configuration 306 may comprise means for configuring the analytics platform 110 to access one or more of a source dataset 105, data store 104, DMS 102 and/or the like. The source configuration 306 may include, but is not limited to: addressing data, network address data, authentication credentials, user authentication credentials, access interface information, query data, a query template, and/or the like). The source configuration 306 of a column 307 of the dataset 305 may comprise a name and/or other identifier of a particular element and/or column of the source dataset 105.

By way of non-limiting example, the source configuration 306 of a dataset corresponding to source dataset 105 embodied as an SQL table may comprise means for configuring the analytics platform 110 to access the data store 104 and/or DMS 102 comprising the SQL table (e.g., an address, authentication credentials, SQL driver, and/or the like). The source configuration 306 may further comprise a name of the SQL table, information pertaining to columns of the SQL table (each column represented by a respective column 307), a query template, and/or the like. The query template may comprise, for example, “SELECT %COLUMNS% FROM <DATASET_NAME> WHERE %CONDITIONS%,” in which “%COLUMNS%” is a placeholder for specifying columns to extract from the source dataset 105 (as defined in one or more columns 307 of the dataset 305), “<DATASET_NAME>” is the name of the SQL table comprising the source dataset 105 (as defined in the source configuration 306), and “%CONDITIONS%” is a placeholder for specifying one or more conditions, filters, limits, and/or the like. In another example, the source configuration 306 for a dataset 305 corresponding to a source dataset 105 having an HTTP interface may comprise an template HTTP query string, such as “GET/data/v1/:datasetname?:queryOperators,” where “/data/v1” corresponds to an HTTP address of the data store 104 and/or DMS 102 comprising the source dataset 105, “datasetname” is a name of the source dataset 105, and “queryOperators” is a placeholder for use in specifying elements to extract from the source dataset 105 (as defined by one or more columns 307 of the dataset 305).

As disclosed above, the source configuration 308 of a column 307 may reference an existing, predefined element and/or column of a source dataset 305. As used herein, the columns 307 of a dataset 305 having source configurations 307 that specify a single, predefined element and/or column of a source dataset 105 may be referred to as “native” columns 307. Column data of the native columns 307 of a dataset 305 may be obtained by, inter alia, issuing a query to the source dataset 105, as disclosed above. The distributed data model 130 may be further configured to provide for defining additional, non-native columns 307 of a dataset 305. As used herein, a “non-native” or “derived” column 307 refers to a column 307 having a source configuration 308 that defines means for calculating and/or deriving the column 307 (as opposed to obtaining data of the column from a specified field/column of a source dataset 105). The source configuration 308 of a derived column 307 may define means for calculating and/or deriving the column 307 (e.g., define a calculation by which the column 307 may be calculated and/or derived). The source configuration 308 of a derived column 307 may define means for calculating and/or deriving the column 307 from one or more other columns 307. A column 307 having a source configuration 308 that depends on one or more other columns 307 may be referred to as a “dependent” or “dependent derived” column 307. A column 307 that is referenced in the source configuration of dependent column 307 may be referred to as a source column 307.

A dataset 305 may further comprise one or more dataset aliases (alias 315). As disclosed in further detail herein, an alias of a dataset 305 may comprise a name, label, or other suitable identifying for use in linking the dataset 305 to one or more other datasets 305 (e.g., defining a distributed dataset spanning a plurality of datasets 305). As used herein, a “linked dataset” refers to a dataset 305 that is linked to one or more other datasets 305 (e.g., has a same alias 315 as the one or more other datasets 305). Assigning a particular dataset alias 315 to one or more datasets 305 may, therefore, define a distributed dataset spanning the datasets 305 linked to the particular alias 315. In some embodiments, the distributed data model 130 may maintain modeling data pertaining to datasets aliases 315 and/or the datasets 305 linked thereto by use of distributed dataset objects (distributed datasets 325). A distributed dataset 325 may comprise and/or correspond to a specified dataset alias 315. In some embodiments, a distributed dataset 325 may further comprise a datasets field, which may comprise reference(s), link(s), and/or other means for identifying the datasets 105 linked thereto (datasets 305 linked to the specified dataset alias 315). Alternatively, the datasets 305 linked to a particular alias 315 may be determined by, inter alia, searching the distributed data model 130 for datasets 305 having the particular alias 315 (e.g., without representing distributed datasets 325 and/or the linked datasets by use of dedicated distributed dataset objects 325).

Linked datasets 305 may comprise linked columns 307. As used herein, a linked column 307 refers to a column 307 of a dataset 305 that is linked to one or more columns 307 of other datasets 305 linked to the dataset 305. A column 307 may be linked to the one or more other columns by use of a column alias (alias 317). Alternatively, or in addition, columns 307 of a linked dataset 305 may be linked to columns 307 of other linked datasets 305 by use of a name, label, and/or other identifying information (e.g., the modeler 121 may link a “Date” column 307 of a first linked dataset 105 to “Date” columns 107 of other datasets 305 linked to the first dataset 105 based on, inter alia, the names of the columns 107). Operations performed on a linked column 307 and/or distributed column 325 may be performed on each column 307 linked thereto. In some embodiments, the distributed data model 130 may provide for representing linked columns 307 by use of a distributed column object (a distributed column 327). A distributed column 327 may specify a column alias 317. A distributed column 327 may further comprise reference(s), link(s), and/or other means for identifying the columns 107 linked thereto (e.g., columns 107 of linked datasets 305 assigned the specified column alias 317). Alternatively, linked columns 307 may be determined by, inter alia, evaluating the column names and/or aliases 317 of the columns 307 of the linked datasets 305 within the distributed data model 130 (e.g., without the use of separate distributed columns objects 327).

Referring back to FIG. 1, the configuration manager 120 may comprise a modeler 121, which may be configured to maintain distributed data model(s) 130 corresponding to the distributed architecture 101 (and/or distributed data maintained therein). In some embodiments, the modeler 121 is configured to determine modeling data pertaining to the distributed architecture 101 and/or populate the distributed data model 130 with the determined modeling data (e.g., create corresponding records in the distributed data model 130). The modeler 121 may be configured to automatically populate portions of the distributed data model 130. The modeler 121 may be configured to obtain information pertaining to usable DMS 102, data stores 104, and/or source datasets 105, acquire modeling data therefrom, and/or incorporate the acquired modeling data into the distributed data model 130. The modeler 121 may be configured to acquire modeling data using any suitable mechanism including, but not limited to: issuing queries through interface(s) of respective DMS 102, data stores 104, and/or source datasets 105, querying interface(s) of respective DMS 102 to identify accessible data stores 104 managed thereby, querying interface(s) of respective data stores 104 to identify accessible source datasets 105 thereof, querying interface(s) of respective source datasets 105, accessing service description data pertaining to respective DMS 102, data stores 104, and/or source datasets 105 (e.g., service description data, Web Service Description Language (WSDL) data, Universal Description Discovery and Integration (UDDI) data, and/or the like), accessing configuration data pertaining to respective DMS 102, data stores 104, and/or source datasets 105 (e.g., schema 103), parsing accessed configuration data (e.g., parsing schema 103, WSDL, UDDI, and/or the like), and/or the like. The modeler 121 may be further configured to incorporate the determined modeling data into a distributed data model 130 (e.g., create model entries representing DMS 102, data stores 104, source datasets 105, and/or the like).

In some embodiments, the modeler 121 is configured to acquire initial configuration data pertaining to one or more DMS 102, data stores 104, and/or source datasets 105. As used herein, “initial configuration data” refers to configuration data for accessing the one or more DMS 102, data stores 104, and/or source datasets 105 (e.g., address information, authentication credentials, interface information, and/or the like). The modeler 121 may be configured to receive and/or prompt users for initial configuration data through, inter alia, a model interface 123. Alternatively, or in addition, the modeler 121 may be configured to acquire initial configuration data from other sources (e.g., a user directory, service description data, and/or the like). In response to obtaining initial configuration data, the modeler 121 may be configured to automatically determine modeling data, and populate the distributed data model 130 with the additional modeling data, as disclosed herein. In response to obtaining initial configuration data pertaining to a particular DMS 102, the modeler 121 may be configured to access the particular DMS 102 (via the network 106), identify data stores 104 and/or source datasets 105 managed thereby (and/or the schema 103 of the identified data stores 104 and/or source datasets 105), and populate the distributed data model 130 with the determined modeling data, as disclosed herein. In response to acquiring initial configuration data pertaining to a particular data store 104, the modeler 121 may be configured to access the particular data store 104, identify source datasets 105 maintained therein, determine modeling data pertaining to the identified source datasets 105 (e.g., the schema 103 of the identified source datasets 105), and populate the distributed data model 130 with the determined modeling data, as disclosed herein. In response to acquiring initial configuration data pertaining to a particular source dataset 105, the modeler 121 may be configured to access the particular source dataset 105, determine modeling data pertaining to the particular source dataset 105 (e.g., the schema 103 of the particular source dataset 105), and populate the distributed data model 130 with the determined modeling data, as disclosed herein. The modeler 121 may be configured to create a new dataset 305 corresponding to the source dataset 105. The modeler 121 may be further configured to create columns 307 of the new dataset 305, each column 307 corresponding to a respective native element and/or column of the source dataset 105. The modeler 121 may be further configured to populate the configuration of respective column 307, such as the column name, label, and/or the like. The modeler 121 may be further configured to populate the source configuration 308 of the respective columns 307 (e.g., specify the particular native elements and/or columns of the source dataset 105 corresponding to the respective columns 307). The modeler 121 may be further configured to classify the columns 307 (as one of a dimension and/or measure). The modeler 121 may be configured classify columns 307 in accordance with pre-determined classification rules, which may correspond to semantic information pertaining to the columns 307 (e.g. the column type). The pre-defined classification rules may specify that columns 307 matching designated criteria. The criteria may pertain to any suitable information pertaining to the column 307 including, but not limited to: semantic information (e.g., column name, label, tag, description, identifier, alias, and/or the like), column type (e.g., data type), source configuration 308, and/or the like. The criteria for classification as a dimension column 307 may define a set of terms, phrases, and/or the like, determined to be indicative of the dimension classification (e.g., “date,” “year,” “name,” “product,” “type,” “region,” “identifier,” and/or the like). Alternatively, or in addition, the criteria of the dimension classification may pertain to the column type (e.g., specify data types, such as character, string, date, enumerated values, symbol values, and/or the like). The criteria for classification as a measure column 307 may define a set of terms, phrases, and/or the like, determined to be indicative of the measurement classification (e.g., “revenue,” “count,” “profit,” “cost,” “seconds,” “minutes,” and/or the like). Alternatively, or in addition, the criteria of the measure classification may pertain to the column type (e.g., specify data types, such number, INT, FLOAT, and/or the like).

The configuration manager 120 may comprise an interface engine 122, which may be configured to provide, generate, and/or implement interface(s) for creating, modifying, and/or managing a distributed data model 130, data analysis and/or visualization components 140, and/or the like. As used herein, a data analysis and/or visualization (DAV) component 140 may refer to means for defining one or more data analytics and/or visualizations, which may comprise means for configuring the analytics platform 110 to perform operations for implementing the defined data analytics and/or visualizations, which operations may include, but are not limited to: operations for accessing, reading, querying, and/or otherwise obtaining portions of a target dataset, operations for calculating, transforming, deriving, and/or generating portions of the target dataset (e.g., data transform operations, data look-up operations, etc.), data analysis operations (e.g., calculations, aggregations, filter operations, sorting operations, series operations, and/or the like pertaining to the target dataset), data visualization operations, and/or the like. The means for defining the data analytics and/or visualizations of a DAV component 140 and/or the means for configuring the analytics platform 110 to perform operations for implementing the defined analytics and/or visualizations may include, but are not limited to: data structures (e.g., a data structure configured to define a set of parameters and/or reference a distributed data model 130), instructions, machine-readable instructions, computer-readable instructions, machine-readable instructions, executable instructions, executable code, interpretable code, scripts (e.g. JavaScript, Python, Ruby, Perl, and/or the like), process control code (e.g., Work Flow Language (WFL) code), firmware code, configuration data, and/or the like. As disclosed herein, the data analysis and/or visualization operations of a DAV component 140 pertain to data maintained within the distributed architecture, including distributed data spanning multiple source datasets 105, data stores 104, DMS 102, and/or the like. In some embodiments, DAV components 140 may reference such data by use of the distributed data model 130, as disclosed herein.

FIG. 3B illustrates one embodiment of an interface 124 for managing a distributed data model 130. The interface 124, and/or the other interfaces 122 disclosed herein, may comprise means for providing and/or implementing any suitable interface including, but not limited to: a graphical user interface, a touch user interface, a haptic feedback user interface, a mobile device interface, a text user interface, an application interface, a browser-based interface (e.g., one or more Web pages embodied as, inter alia, markup data), and/or the like.

The interface 124 may be communicatively coupled to a distributed data model 130. A dataset control 332 may be configured to manage usable datasets 305 of the distributed data model 130. Usable datasets 305 may be represented by use of respective dataset components 333 (e.g., dataset components 333A-N). A dataset entry 333 may be added to the dataset control 332 by use of an “Add Dataset” input. As illustrated in FIG. 3C, selection of the “Add Dataset” input may invoke an add dataset control 334, which may provide for one or more of: selection of an existing usable dataset 305, creation of a new usable dataset 305, and/or the like. Creation of a new usable dataset 305 may comprise one or more of inputting dataset configuration data pertaining to a source dataset 105 (e.g., manually defining properties of the dataset 305), inputting initial configuration data pertaining to a source dataset 105, and/or the like. In response initial configuration data pertaining to a source dataset 105, the modeler 121 may be configured to determine modeling data pertaining to the source dataset 105, and populate the distributed data model 130 with the determined modeling data (e.g., create a new dataset 305 comprising the determined modeling data), as disclosed herein.

The dataset components 333A-N may represent selected usable datasets 305, each dataset component 333A-N having a respective label, which may correspond to a name, alias 315, and/or other identifying information of respective dataset 305. In response to selection of a dataset component 333, the interface 124 may be configured to update the components thereof to display information pertaining to the corresponding dataset 305 (the selected dataset 305). In the FIG. 3C embodiment, the dataset component 333B may be selected and, as such, the interface 124 may be configured to display information pertaining to columns 307 of the corresponding dataset 305. The interface 124 may comprise a dimensions component 342, which may be configured to display entries 343 representing respective dimension columns 307 of the selected dataset 305. As disclosed above, the dimension columns 307 may comprise columns 307 of the selected dataset 305 that are classified as dimensions, and the measure columns 307 of the dataset 307 may comprise columns 307 of the selected dataset 305 that are classified as measures. The classification of a column 307 of the selected dataset 305 may be modified by, inter alia, dragging a column entry 343 from the dimensions component 342 to the measures component 352 and/or dragging a column entry 352 from the measures component 352 to the dimensions component 342. In response, the modeler 121 may determine whether the column 107 is suitable for reclassification and, if so, may modify the classification of the column 107 accordingly (change the classification of the column 307 in the distributed data model 130). If the modeler 121 determines that the column 107 is not suitable for reclassification (is not suitable for use as a dimension or measure), the modeler 121 may retain the previous classification of the column 307 (and/or may display a notification indicating why the column 307 was not reclassified as requested).

The dataset components 333 may comprise an edit input. In response to selection of the edit input of a dataset entry 333, the interface 124 may be configured to invoke a dataset management control 336. The dataset management control 336 may comprise means for managing characteristics of a dataset 305, which may include, but are not limited to: means for assigning a new alias to the dataset 305, means for modifying an alias of the dataset 305, means for removing a selected alias of the dataset 305, and/or the like. The means may comprise interface components, input components, graphical user interface elements, and/or the like.

The dimensions component 342 may be configured to display information pertaining to dimension columns 307 of the selected dataset 305 by use of respective dimension components 343. In the FIG. 3B embodiment, dimension components 343A-N represent respective dimension columns 307 of the selected dataset 305. Column labels of the dimension components 343A-N may correspond to a name, label, tag, identifier, alias, and/or other identifying information associated with the respective dimension columns 307.

The measures component 352 may be configured to display information pertaining to dimension columns 307 of the selected dataset 305 by use of respective measure components 353. In the FIG. 3B embodiment, measure components 353A-N represent respective measure columns 307 of the selected dataset 305. Column labels of the measure components 353A-N may correspond to a name, label, tag, identifier, alias, and/or other identifying information associated with the respective measure columns 307.

The column components 343 and/or 353 may comprise an edit input, selection of which may configure the interface 124 to invoke a column management control 338. The column management control 338 may comprise means for managing characteristics of a selected column, which may include, but are not limited to: means for assigning a new alias to the column 307, means for modifying an alias of the column 307, means for removing a selected alias of the column 307, means for specifying the source configuration 308 of the column 307. As disclosed above, the source configuration 308 of a column may specify an particular element and/or column of a source dataset 105. Alternatively, the source configuration 308 may comprise instructions for calculating and/or deriving the column 307 (e.g., from one or more other columns 307). The means may comprise interface components, input components, graphical user interface elements, and/or the like.

The interface 124 may enable users to manage data that spans multiple source datasets 105, data stores 104, DMS 102, and/or the like. As disclosed above, the interface 124 may be configured to manipulate a distributed data model 130 which may be configured to represent, inter alia, data maintained in a distributed architecture, such as the distributed architecture 101, illustrated in FIG. 1. The distributed data model 130 may define datasets 305, which may correspond to source datasets 105 maintained within respective data stores 104, DMS 102, and/or the like.

FIG. 3C illustrates another embodiment of a distributed data model 130A. The distributed data model 130A may populated by the modeler 121 in response to initial configuration data, as disclosed herein. The distributed data model 130A may correspond to source datasets 105A-N as illustrated in FIGS. 1 and 2A. As illustrated in FIG. 3C, the modeler 121 may be configured to populate the distributed data model 130 with information pertaining to datasets 305A-N, each dataset 305A-N corresponding to a respective source dataset 105A-N. As illustrated in FIG. 3C, the modeler 121 may be further configured to: populate dataset 305A with columns 307AA-AN corresponding to the “Date,” “Brand,” and “Total seconds” columns of source dataset 105A; populate dataset 305B with columns 307BA-BN corresponding to the “Date, “CN,” and “Total seconds” columns of source dataset 105B; and so on; with dataset 305N being populated with columns 307NA-NN corresponding to the “Date,” “NW,” and “Minutes” columns of source dataset 105N. The source configuration 308AA-NN of each column 307AA-NN may reference a specified element and/or column of a respective source dataset 105A-N. The columns 307AA-NN may, therefore, be referred to as native columns 307. As disclosed above, a native column 307 refers to a column 307 that corresponds to an existing, pre-defined element and/or column of a source dataset 105 (e.g., a column 307 having a source configuration 308 that references a single element and/or column of the source dataset 105).

The modeler 121 may be further configured to classify respective columns 307AA-NN as dimension or measure columns 107. The modeler 121 classify the columns 307AA-NN in accordance with one or more classification rules, as disclosed above. The modeler 121 may classify columns 307AA-AB, 307BA-BB, and 307NA-NB as dimension columns 307, and nay classify columns 307AN, 307BN, and 307NN as measure columns 307 (based on the name and/or data types thereof).

FIG. 3D illustrates another embodiment of an interface 124 for creating, modifying, and/or managing a distributed data model 130. In the FIG. 3D embodiment, the interface 124 is configured to provide for the development, modification, and/or management of the distributed data model 130A illustrated in FIG. 3C. As disclosed above, the distributed data model 130A may comprise datasets 305A-N, comprising columns 307AA-AN, 307BA-BN, through 307NA-NN, respectively. The datasets 305A-N and columns 307AA-NN may have been included in the distributed data model 130A by the modeler 121, as disclosed herein (e.g., in response to initial configuration data pertaining to source datasets 105A-N).

The interface 124 may be configured to provide for creation of a distributed dataset 325 spanning a plurality of datasets 305A-N. As illustrated in the FIG. 3D embodiment, the dataset management control 336, may be used to add entries 333A-N to the dataset control 332, each entry 333A-N representing a respective one of the datasets 305A-N. Adding an entry 333A-N may comprise selecting the “Add Dataset” input to invoke the dataset control 334. The dataset control 334 may provide for selecting a dataset 305 of the distributed data model 130A to include in the dataset control 332 (e.g., may provide for selecting respective datasets 305A-N populated by the modeler 121, as described above).

As illustrated in FIG. 3E, selection of the edit input of the entry 333A, may configured the interface 124 to invoke a dataset management control 336 adapted to modify characteristics of the corresponding dataset 305 (dataset 305A). In the FIG. 3E embodiment, the dataset management control 336 may be used to assign the alias 315A of the dataset 305A (add a new dataset alias 315A, “Portal Data”). In response to assigning the “Portal Data” alias 315A to dataset 305A, the modeler 121 may implement corresponding modifications in the distributed data model 130A. FIG. 3E depicts modifications to the distributed data model 130A (other, unmodified portions of the distributed data model 130A are not shown in FIG. 3E to avoid obscuring details of the depicted embodiments). As illustrated, the modifications may comprise: modifying the dataset 305A to assign the “Portal Data” alias 315A thereto, and creating a distributed dataset 325A corresponding to the “Portal Data” alias 315A.

FIG. 3F depicts further modifications to the distributed data model 130A implemented by use of, inter alia, the interface 124. As illustrated in FIG. 3F, the dataset management control 336 may be utilized to assign the “Portal Data” alias 315A to dataset 305B. In response, the modeler 121 may implement corresponding modifications within the distributed data model 130A. As illustrated in FIG. 3E, the modeler 121 may be configured to link datasets 305A and 305B (by use of the alias 315A and/or distributed dataset 325A).

FIG. 3G depicts further modifications to the distributed data model 130A implemented by use of, inter alia, the interface 124. As illustrated in FIG. 3G, the dataset management control 336 may be utilized to assign the “Portal Data” alias 315A to each of the datasets 305A-N. In response, the modeler 121 may implement corresponding modifications within the distributed data model 130A. As illustrated in FIG. 3E, the modeler 121 may be configured to link datasets 305A-N (by use of the alias 315A and/or distributed dataset 325A). The distributed dataset 325A may, therefore, represent dataset spanning datasets 305A-N (and/or source datasets 105A-N, data stores 104A-N, DMS 102A-N, and so on).

Although the datasets 305A-N may be linked to a same alias 315A-N, it may be difficult to develop analytics that span the linked datasets 305A-N due to, inter alia, differences in the schema 103A-N thereof (e.g., each dataset 305A-N may comprise different columns 307 having different names, types, and/or like). By way of non-limiting example, each dataset 305A-N may use a different column to track network content (e.g., different “Brand,” “CN,” and/or “NW” columns 307). The configuration manager 120 may provide for linking such columns despite differences therebetween. As illustrated in FIG. 3H, the interface 124 may provide for assigning a column alias 317A (“Network”) to the “Brand” column 307AB of dataset 305A (by use of the column management control 338, as disclosed herein). In response to assigning the column alias 317A, the modeler 121 may implement corresponding in the distributed data model 130A. FIG. 3H depicts modifications to the distributed data model 130A corresponding to assignment of the “Network” column alias 317A (other, unmodified portions of the distributed data model 130A are not shown in FIG. 3H to avoid obscuring details of the depicted embodiments). As illustrated, the modifications may comprise assigning the “Network” column alias 317A to column 307AB and/or creating a distributed column 325 corresponding to the “Network” column alias 317A, which may reference the linked column 307AB.

FIG. 3I illustrates use of the interface 124 to assign the “Network” column alias 317A to column 307NB of dataset 305N (after assigning the “Network” column alias 317A to column 307BB of dataset 305B). As shown in FIG. 3I, the dataset component 333N corresponding to dataset 305N may be selected, which may cause the interface 124 to populate the dimensions and/or measures components 342/352 with columns 307NA-NN of dataset 305N. Selection of the edit input of the column component 343B corresponding to column 307NB may configure the interface 124 to invoke the column management control 338, which may provide for assigning the “Network” column alias to column 307NB. In response to the assigning, the modeler 121 may implement corresponding modifications in the distributed dataset 130A, which may comprise assigning the alias 317A to column 307NB, modifying the distributed column 325 to reference column 307NB, and/or the like (as illustrated, the “Network” column alias 317A may have been previously assigned to column 307BB of dataset 305B).

The modeler 121 may be configured to link columns 307 having a same name and/or other identifying information. Therefore, the “Date” columns 307AA-NA may comprise linked columns of the linked datasets 305A-N. In addition, the “Total seconds” columns 307AN-BN of datasets 305A and 305B may comprise linked columns of the linked datasets 305A and 305B. The dataset 305N, however, may not comprise a “Total seconds” column. Accordingly, operations pertaining to the “Total seconds” linked column may exclude dataset 305N. Moreover, the dataset 305N may not comprise column 307 suitable to be linked and/or aliased to the “Total seconds.” Linking the “Minutes” column 307NN of dataset 305N would result in erroneous results since, inter alia, the “Minutes” column of dataset 305N tracks content distribution by “Minutes” rather than “Total seconds.”

As disclosed above, the modeler 121 may comprise means for defining, additional non-native columns 307. FIG. 3J illustrates use of the interface to define a non-native calculated column 307NO, which may be linked to the “Total seconds” columns 307AN and 307BN. As illustrated in FIG. 3J, selection of the “Create Column” input, while dataset 305N is selected in the dataset control 332, may configure the interface 124 to invoke a create column control 339 configured to provide for creating one or more columns 307 of dataset 305N. The create column 339 control 339 may provide for specifying a column name, identifier, type, classification, and/or the like. In the FIG. 3J embodiment, the new column 307NO created for dataset 305N may be named “Total seconds,” have a data type of NUM, and be classified as a measure (MES). The create column control 339 may further provide for defining means for configuring the analytics platform 110 to obtain column data of column 307NO (e.g., define a source configuration 308NO). The source configuration 308NO may define a calculation for deriving the “Total seconds” column 307NO from the “Minutes” column 307NN (e.g., by scaling data of column 307NN by an appropriate scaling factor). In response to creating the column 307NO, the modeler 121 may implement corresponding modifications within the distributed data model 130A, which may comprise adding the column 307NO to dataset 305N, and/or the like. The modeler 121 may be further configured to link the column 307NO to the “Total seconds” columns 307AB and 307BB of linked datasets 305A and 305B, such that operations.

As disclosed above, the configuration manager 120 of the analytics platform 110 may be configured to provide for creating, modifying, and/or managing DAV components 140. A DAV component 140 may comprise means for defining data analytics and/or visualizations pertaining to data corresponding to the distributed data model 130 (and/or means for configuring the analytics platform 110 to perform operations for implementing the defined data analytics and/or visualizations). DAV components 140 may, therefore, define operations pertaining to specified data, which data may be specified by reference to a distributed data model 130 (e.g., may reference datasets 305, columns 307, distributed datasets 315, distributed columns 317, distributed columns 327, and/or the like).

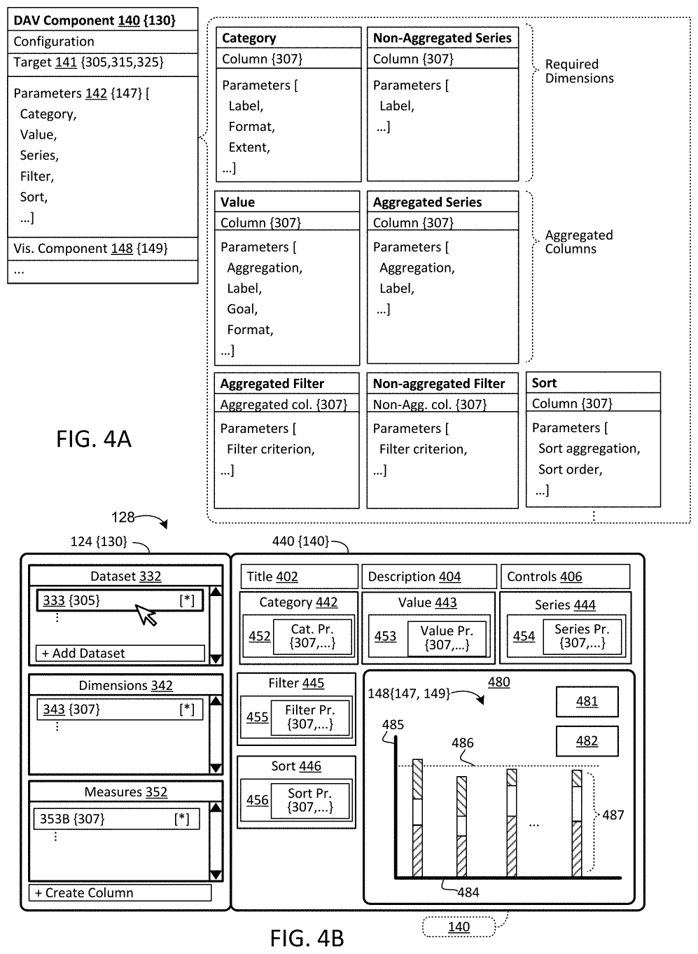

FIG. 4A illustrates embodiments of a DAV component 140, as disclosed herein. A DAV component 140 may comprise a configuration which may, inter alia, define a name, title, description, identifier, and/or other information pertaining thereto. The configuration of a DAV component 140 according to the FIG. 4A embodiments may be configured to define data analytics, analysis, and/or visualization operations pertaining to a selected target dataset 141. The target dataset 141 may correspond to a distributed data model 130 managed by the analytics platform 110. The target dataset 141 of a DAV component 140 may correspond to one or more of a dataset 305, a linked dataset 305, a dataset alias 315, a distributed dataset 325, and/or the like (as defined in the distributed dataset model 130, as disclosed herein).

The DAV component 140 may comprise means for configuring the DAV platform 110 to produce an output dataset 147 corresponding to the target dataset 141. The DAV component 140 may define operations by which the output dataset 147 may be generated from data of the target dataset 141, which operations may include, but are not limited to: specifying an extent of the target dataset 141, designating column(s) 307 of the target dataset 141, and/or the like. As used herein, an “extent” of a dataset may refer to a specified portion, range, grouping, aggregation, and/or granularity of the dataset. The extent of a dataset, such as the target dataset 141, refers to a range covered by entries of the dataset with respect to a specified dimension, a granularity of the entries with respect to the specified dimension, an aggregation or grouping of the entries with respect to the specified dimension, and/or the like (e.g., an extent may refer to a “slice” of the dataset). By way of non-limiting example, the extent of a dataset with respect to a “date” column thereof may refer to the range of dates covered by the dataset. A specified extent of the dataset may, therefore, refer to a specified subset of the full extent covered thereby (e.g., a “slice” of the full date range). Alternatively, or in addition, the extent of a dataset may refer to grouping and/or aggregation with respect to the specified dimension. By way of further non-limiting example, a specified extent of the “date” column of a dataset may refer to grouping entries of the dataset by a particular date granularity (e.g., a dategrain or grouping by “day,” “week,” “month,” “quarter,” “year,” and/or the like). An extent may further refer to filtering with respect to the specified dimension (e.g., filtering by selected dates, date ranges, and/or the like).

Although particular examples for means for defining an extent of a dataset are described herein, the disclosure is not limited in this regard and could be adapted to provide for specifying an extent and/or subset of a dataset using any suitable means.

A DAV component 140 may comprise means for designating column(s) 307 of the target dataset 141 and/or designating an arrangement and/or transform operations pertaining to the designated column(s) 307 (e.g., may define operations for dicing the target dataset 141). The means for configuring the analytics platform 110 to produce the output dataset 141 may comprise one or more of: executable code, intermediate code, byte code, a library, a shared library (e.g., a dynamic link library, a static link library), a module, a code module, an executable module, firmware, configuration data, interpretable code, downloadable code, script code (e.g. JavaScript, Python, Ruby, Perl, and/or the like), a script library, and/or the like. In the FIG. 4A embodiment, the means may comprise a plurality of parameter 142, each parameter corresponding to a respective column 307 of the target dataset 141. The DAV component 140 may comprise one or more of category, value, series, filter, and/or sort parameters 142. The category parameter 142 may specify a column 307 of the target dataset 141, which may be designated as a primary dimension of the output dataset 147 (e.g., may define the x-axis of a Cartesian-based data visualization of the output dataset 147). The category parameter may further define one or more of: a label, format, and/or extent of the category column 307. The label may comprise a human-readable label for use in a data visualization of the output dataset 147 (e.g., table, graphical visualization, and/or the like). The format property may specify a display format for the category column 307 of the output dataset 147 (e.g., a date display format, and/or the like). The extent property may indicate an extent for the category column 307 (e.g., specify an extent of the target dataset 307, such as a date range, date grain, groupby, filter, and/or the like, as disclosed above). As disclosed in further detail herein, the category column 307 may comprise a required dimension of the target dataset 141 (e.g., a column 307 required to be included in each dataset 307 linked to the target dataset 141).

The value parameter 142 may specify a measure column 307 of the target dataset 141, which may be used as the primary aggregation and/or measure column 307 of the output dataset 147 (e.g., may define the y-axis of a Cartesian-based visualization of the output dataset 147). The value column 307 may comprise an aggregated column 307 of the output dataset 307. As used herein, an “aggregated column” 307 refers to a column 307 pertaining to a specified aggregation operation (e.g., an aggregation operation by which the output dataset 147 is produced from the target dataset 141). The value parameter 142 may specify and/or define any suitable aggregation, including, but not limited to: a sum (SUM), a minimum (MIN), a maximum (MAX), an average (AVE), a count (Count), and/or the like. The category parameter may further define one or more of: a label, goal, and/or format of the value column 307. The label may comprise a human-readable label for use in a data visualization of the value column 307 of the output dataset 147 (e.g., table, graphical visualization, and/or the like). The goal may define one or more thresholds pertaining to the value column 307 (which may be displayed and/or indicated on a data visualization, table, interface, and/or the like). The display format may specify formatting of the value column 307, as disclosed herein.

In some embodiments, the parameters 142 may further comprise one or more non-aggregated series parameter(s), which may specify additional columns 307 of the target dataset 141 for use as dimensions within the output dataset 147. A non-aggregated series parameter 142 may specify a column 307 of the target dataset 141 and define a label for the non-aggregated series column 307 (e.g., for use in a visualization of the output dataset 307, as disclosed herein).

In some embodiments, the parameters 142 may further comprise one or more aggregated series parameter(s), which may specify additional columns 307 of the target dataset 141 for use as aggregation columns within the output dataset 147. An aggregated series parameter 142 may designate an aggregation column 307 of the target dataset 141, specify an aggregation operation to perform on the designated column 307, define a label for the aggregated series column 307, and so on, as disclosed herein.

In some embodiments, the parameters 142 may further comprise one or more filter parameter(s), which may specify filter operations to perform with respect to the target dataset 141 (e.g., filter entries of the target dataset 141 for inclusion in the output dataset 147. The parameters 142 may include an aggregated filter parameter, which may specify an aggregated column 307 of the output dataset 147 (e.g., a column 307 on which an aggregation operation is performed). The parameters 142 may further include a non-aggregated filter parameter, which may specify a non-aggregated column of the output dataset 147 (e.g., a column 307 not used as an aggregation column, such as a dimension column 307, and/or the like). A filter parameter may further specify and/or define one or more filter criteria, which may define conditions pertaining to the specified column 307. The filter criteria may be adapted in accordance with the type of the specified column 307 (e.g., character, string, NUM, enumerated values, symbols, and/or the like). The filter criteria pertaining to a column 307 comprising enumerated values may filter based on whether designated values are “In” or “Not In” respective entries of the column 307 (e.g., whether designated region codes, such as “North,” “South,” “East,” and/or “West,” are “In” or “Not In” entries of the column 307). Filter criteria corresponding to numeric and/or Date column data may comprise a suitable comparator (e.g., greater than, less than, equal to, within specified thresholds and/or ranges).

In some embodiments, the parameters 142 may further comprise one or more sort parameter(s), which may specify sorting operations on the output dataset 147. A sort parameter 142 may specify a sort column 307 for use in sorting the output dataset 417. A sort parameter 142 may specify and/or define a sort aggregation (e.g., Count, MAX, MIN, SUM, AVE, “No Aggregation,” or the like) and a sort order (e.g., ascending, descending, and/or the like). A sort column 307 having “No Aggregation” may be referred to as a non-aggregated sort column 307, and a sort column having an aggregation 140 other than “No Aggregation” may be referred to as an aggregated sort column 307.

As disclosed above, the parameters 142 of the DAV component 140 may define operations by which an output dataset 147 may be produced from the target dataset 141. The target dataset 141 may correspond to a plurality of linked datasets 305 (e.g., a plurality of datasets 305 associated with a same alias 315). The operations of the DAV component 140 may be performed on each linked dataset 305 such that the output dataset 147 spans the plurality of datasets 305 linked to the target dataset 141. Moreover, the columns 307 referenced by parameters 142 of the DAV component 140 may comprise linked columns 307 and, as such, operations on a column 307 may be performed on each column 307 linked thereto. Columns 307 of the output dataset 147 may, therefore, span a plurality of linked columns 307 (a column 307 of each linked dataset 305). Producing the output dataset 147 may comprise implementing one or more global operations and/or or more dataset-specific operations. As used herein, a “global” operation refers to an operation pertaining to one than one dataset 305 (e.g., an operation pertaining to a linked column 307 and/or columns 307 of more than one datasets 305). As used herein, a “dataset-specific” operation refers to an operation that uses columns of a single dataset 305 (e.g., an operation to calculate a column 307 of a dataset 305 from another column 307 of the dataset, such as calculation of the “Total seconds” column 307NO from the “Minutes” column 3077 of dataset 305N, as disclosed above).

In the FIG. 4A embodiment, a DAV component 140 may comprise and/or define a visualization 148 of the output dataset 147. The visualization 148 may comprise any suitable means for specifying and/or defining a data visualization including, but not limited to: configuration data, instructions, computer-readable instructions, executable code, script code (e.g., JavaScript code), code libraries, markup code, user interface components, graphical interface components, and/or the like. The visualization component 148 may define any suitable type of data visualization and/or properties thereof, including, but not limited to: a bar chart, grouped bar chart, stacked bar chart, grouped area chart, stacked area chart, line chart, area chart, pie chart, table, bubble chart, visualization display size, visualization coloration, visualization language, visualization granularity, visualization extent, and/or the like. The visualization 148 may further comprise and/or maintain a visualization state 149. As disclosed in further detail herein, the visualization state 149 may be configured to indicate a viewable extent of the visualization 148, which may, in turn, determine the extent of the category parameter 142 (and/or output dataset 147).

FIG. 4B depicts one embodiment of an interface 128 for developing, modifying, and/or implementing DAV components 140, such as the DAV component 140 illustrated in FIG. 4A. In the FIG. 4B embodiment, the interface 128 may comprise means for providing and/or implementing any suitable interface including, but not limited to: a graphical user interface, a touch user interface, a haptic feedback user interface, a mobile device interface, a text user interface, an application interface, a browser-based interface (e.g., one or more Web pages embodied as, inter alia, markup data), and/or the like.

The interface 128 may comprise a title component 402, description component 404, control components 406, and/or the like. The title and description components 402, 404 may provide for specifying a title and/or description of a DAV component 140. The controls 406 may provide for, inter alia, saving a DAV component 140 (as currently defined within the interface 128), loading saved DAV components 140 into the interface 128, and/or the like. The configuration manager 120 may maintain DAV components 140 within non-transitory storage, such as non-transitory storage resources of the computing device 111, a data store 104, a DMS 102A-N, and/or the like.

The interface 128 may be configured to provide for creating, modifying, and/or managing a distributed data model 130. The interface 128 may comprise portions of the interface 124, as disclosed herein (e.g., may comprise a dataset control 332, dimensions component 342, measures component 352, and/or the like). The dataset control 332 may provide for the creation, modification, and/or selection of the target 141 of a DAV component 140 (the DAV component 140 being created, modified, and/or implemented within the interface 128). The dataset control 332 may comprise dataset components 333, which may represent usable datasets 305, dataset aliases 315, distributed datasets 325, and/or the like. The dataset control 332 may further provide for selection of the target 141 of the DAV component 140 from one or more usable datasets 305, dataset aliases 315, distributed datasets 325, and/or the like. The dimensions component 342 may be configured to display column components 343 representing respective dimension columns 307 of the selected target 141, and the measures component 352 may be configured to display column components 353 representing respective measure columns 307 of the selected target 141, and so on, as disclosed herein.

The interface 128 may further comprise interface components 426 configured to provide for creating, modifying, managing, and/or implementing DAV components 140, as disclosed herein. The interface 128 may comprise components for defining parameters 142 of a DAV component 140, including, but not limited to: a category parameter 442, a value component 443, a series component 444, a filter component 445, a sort component 446, and/or the like.

The category component 442 may be configured to provide for the defining and/or modifying category parameters 142 of DAV components 140. The category parameter 142 of a DAV component 140 may be created by dragging a column entry 343 from the dimensions component 342 to the category component 442 (and/or otherwise designating a dimension column 307 of the selected dataset 305 as the category column 307 for the DAV component 140). The category component 442 may comprise a category properties component 452, which may provide for the creation and/or modification of respective properties of the category parameter 142, which may include, but are not limited to label, format, extent, and/or the like, as disclosed herein.

The value component 443 may be configured to provide for the creation and/or modification of value parameters 142 of DAV components 140. The value parameter 142 of a DAV component 140 may be created by, inter alia, dragging a measure column entry 453 from the measures component 353 to the value component 443 (and/or otherwise designating a measure column 307 of the selected dataset 305 as the value parameter 142 of the DAV component 140). The value component 443 may comprise a value properties component 453, which may provide for the creation and/or modification of respective properties of the value parameters 142, which may include, but are not limited to: an aggregation, label, goal, format, and/or the like, as disclosed herein.

The series component 444 may be configured to provide for the creation and/or modification of series parameters 142 of DAV components 140. A series parameter 142 of a DAV component 140 may be created by, inter alia, dragging a column entry 343/353 to the series component 444 (and/or otherwise designating a column 307 for use in the series parameter 144). The series component 444 may comprise a series properties component 454 configured to provide for the creation and/or modification of the properties of aggregated series parameters 142, which may include, but are not limited to: an aggregation, label, and/or the like, as disclosed herein. The series properties component 454 may be further configured to provide for the creation and/or modification of the properties of non-aggregated series parameters 142 (e.g., by specifying a “No Aggregation” aggregation operation). The series component 444 may be configured to define a plurality of series parameters 142 of a DAV component 140, each series parameter 142 specifying a respective column 307 and having respective properties.

The filter component 445 may be configured to provide for the creation and/or modification of filter parameters 142 of DAV components 140. A filter parameter 142 of a DAV component 140 may be created by, inter alia, dragging a column entry 343/353 to the filter component 445 (and/or otherwise designating a column 307 for use in a filter parameter 142). The filter component 445 may comprise a filter properties component 455 configured to provide for the creation and/or modification of respective properties of filter parameters 142, which may include, but are not limited to: filter criteria, and/or the like, as disclosed herein. The filter component 445 may provide for defining a plurality of filter parameters 142 of a DAV component 140, each filter parameter 145 specifying a respective column 307 and having respective properties 141.

The sort component 446 may be configured to provide for the creation and/or modification of sort parameters 142 of DAV components 140. A sort parameter 142 of a DAV component 140 may be created by, inter alia, dragging a column entry 343/353 to the filter component 446 (and/or otherwise designating a column 307 for use in a sort parameter 142). The filter component 446 may comprise a sort properties component 456, which may provide for the creation and/or modification of respective properties of sort parameters 142, which may include, but are not limited to: a sort aggregation, a sort order, and/or the like, as disclosed herein.

The visualization component 480 may be configured to provide for creation, modification, and/or display of visualizations 148 of DAV components 140. The visualization component 480 may comprise a visualization control 481, which may be configured to provide for defining and/or modifying properties of the visualization component 148, which may include, but are not limited to: visualization type (e.g., stacked bar chart), display size, coloration, and/or the like. The visualization component 480 may further comprise an extent control 482, which may be configured to provide for defining and/or modifying the extent covered by the visualization 148 (and the extent of the output dataset 147 rendered therein).

The analytics platform 110 may be configured implement the DAV component 140 loaded within the interface 128, which may include producing the output dataset 147 as specified by the parameters 142 of the DAV component (and as defined by use of components 442-446 of the interface 440, as disclosed herein). The visualization interface 480 may be configured to render the visualization component 148 (render a data visualization of the output dataset 147 in accordance with the visualization component 148 as defined by use of the visualization interface 480). FIG. 4B illustrates an exemplary rendering of a Cartesian-based visualization 148 comprising a category axis 484 (e.g., dimension or x-axis) and a measure axis 485 (e.g., measure of y-axis). The category axis 484 may comprise the label and/or format in accordance with the category parameter 142 of the DAV component 140. The value axis 486 may comprise a label and/or format in accordance with the value parameter 142 of the DAV component 140. The visualization interface 480 may be further configured to render goal(s) 486 pertaining to the value parameter 142. The visualization interface 480 may be further configured to display value elements 487 in accordance with aggregated and/or non-aggregated series parameters 142 of the DAV component 140.

The visualization interface 480 may further comprise visualization extent control 482. It may not be practical, or even possible, to visualize the full extent a target dataset 141 (e.g., a data visualization covering an overly large extent, at low granularity, may not be capable of conveying useful information). The extent control 482 may provide for specifying an extent and/or granularity of the output dataset 147 visualized therein. As disclosed above, the extent of the output dataset 147 displayed within the visualization interface 480 refers to the extent and/or range covered thereby with respect to the category column 307 of the DAV component 140. For example, the extent of an output dataset 147 having a “Date” category column 307 may refer to the date range covered by the output dataset 147 and/or the granularity thereof (e.g., specify a dategrain property, such as groupby “day,” “week,” “month,” “quarter,” “year,” and/or the like). Alternatively, or in addition, the extent control 482 may define a result limit (e.g., limit the output dataset 147 to a specified number of entries, such as 20,000 entries). The extent control 482 may determine an extent of the output dataset 147 required to power the visualization 148 and, as such, may define, at least in part, the extent property of the category parameter 142.

Referring back to FIG. 1, the analytics platform 110 may comprise a DAV engine 112, which may be configured to interpret, validate, and/or implement DAV components 140. The following description pertains to implementation of a DAV component 140 having a target 141 that corresponds to a plurality of linked datasets 305 (e.g., datasets 305 associated with a particular dataset alias 315 and/or linked to a distributed dataset 325).

The DAV engine 112 may be configured to implement DAV components 140. The DAV engine 122 may be configured to identify the “used datasets” 305 and/or “used columns” 307 of DAV components 140. As used herein, the “used datasets” 305 of a DAV component 140 refer to the datasets 305 involved in producing the output dataset 147 thereof. The used datasets 305 may, therefore, include the datasets 305 linked to the target 141 of the DAV component 140. The datasets 305 linked to the target 141 of the DAV component 140 may be referred to as linked datasets 305. The DAV component 140 may further define “required dimensions” of the linked datasets 305, which may define columns 307 each linked dataset 305 is required to include. The required dimensions of a DAV component 140 may comprise the column 307 of the category parameter 142 thereof (the category column 307). The required dimensions of the DAV component 140 may further include non-aggregated series columns 307 thereof (e.g., columns of non-aggregated series parameters 142 of the DAV component 140, if any). The “used columns” 307 of the DAV component 140 refer to the columns 307 involved in producing the output dataset 147. The used columns 307 may include the columns 307 referenced by the parameters 142 of the DAV component 142 (and/or the columns 307 linked thereto).

In response to a request to implement a DAV component 140, the DAV engine 112 may be configured to identify the used datasets 305 and/or used columns 307 thereof, which may comprise identifying the datasets 305 linked to the target 141 of the DAV component 140, identifying the columns 307 referenced by respective parameters 142 of the DAV component 147 (and/or the columns 307 linked thereto), and so on. The used columns 307 of the DAV component 140 may include derived columns 307 which, as disclosed above, may be calculated and/or derived from one or more specified source columns 307. The used columns 307 of the DAV component 140 further include the source columns 307 involved in the calculation of used columns 307 of the DAV component 140. The used datasets 305 of the DAV component 140 may further include the datasets 305 comprising such columns 307.

The DAV engine 112 may be configured to acquire a result dataset 157 corresponding to each used dataset 305 of the DAV component 140. Acquiring the result datasets 157 may comprise generating a plurality of queries 152, each query corresponding to a respective one of the used datasets 305. The queries 152 for each used dataset 305 may be generated in accordance with the configuration of the respective dataset 305 which may comprise, inter alia, an address of the corresponding source dataset 105, data store 104, DMS 102, and/or the like. The query engine 150 may be configured to de-alias the queries 152, such that the queries 152 reference the source datasets 105 and/or the fields/columns thereof by use of the native naming and/or identifying information thereof as opposed to the aliases 315 and/or 317 by which the datasets 305 and/or columns 307 are linked.

The queries 152 may include query parameters 154, which may correspond to specified fields/column(s) of the source datasets 105. The query parameters 154 may correspond to the parameters 142 of the DAV component 140 (e.g., correspond to the category, value, series, filter, and/or sort parameters 142 of the DAV component 140). The query engine 150 may be configured to de-alias the query parameters 154, as disclosed herein. The query parameters 154 may further specify fields/columns used to derive and/or calculate one or more other columns 307, as disclosed herein. The query parameters 154 determined by the query engine 150 may further comprise limit parameters 155. The limit parameters 155 may comprise specifying which fields/elements to extract from respective source datasets 105 (such that other fields/columns of the source datasets 105 are not included in the result datasets 157 returned in response to the queries 152). The limit parameters 155 may be further configured to specify an extent of the queries 152 (e.g., may limit the queries to a specified extent of the target datasets 105). By way of non-limiting example, the limit parameters 155 may limit the queries 152 to a specified range (e.g., rage range), a specified granularity (e.g., a specified date grain), and/or the like. The query engine 150 may determine such limit parameters 155 based on the extent of the category parameter 142 of the DAV component 140 (and/or visualization extent control 482), as disclosed herein. The limit parameters 155 may reduce a size and/or extent of the result datasets 157, which may reduce the latency and/or overhead for implementation of the DAV component 140. The limit parameters 155 may specify extents that are significantly smaller than the full extent of the source datasets 105, which may enable the DAV complement 140 to be implemented on-demand, and without intervening ETL processing.

The query engine 150 may be further configured to issue each query 152 to a specified dataset 105, data store 104, DMS 102, and/or the like. The queries 152 may be issued in accordance with the configuration of the corresponding dataset 305 which, as disclosed herein, may comprise an address, authentication credentials, driver, and/or other information for use in querying a specified source dataset 105, data store 104, DMS 102, and/or the like. The query engine 150 may be configured to receive, retrieve, and/or otherwise obtain result datasets 157 in response to the queries 152.

The DAV engine 112 may further comprise a transform engine 160, which may be configured to produce the target dataset 147 of the DAV component 140 by use of the result datasets 157 obtained by the query engine 150. The transform ending 160 may be configured to add a unique identifier (UID) column to each result dataset 157. The transform engine 160 may be further configured to produce one or more stacked datasets, each stacked dataset comprising result datasets 157 corresponding to respective linked datasets 305 (e.g., each stacked dataset comprising result datasets 157 corresponding to linked datasets 305 associated with a respective alias 315). The transform engine 160 may be configured to populate the UID column of the stacked datasets. The UID column may be populated with a concatenation of the required dimensions of the stacked dataset (the required dimensions of the linked datasets 305 corresponding to the stacked dataset, as disclosed above). The transform engine 160 may be further configured to re-aggregate the stacked datasets in accordance with the UID column thereof.

The transform engine 160 may be further configured to implement dataset-specific operations pertaining to the result datasets 157 (and/or corresponding stacked datasets). The dataset-specific operations may comprise operations to add derived columns 307 to the result datasets 157 (and/or resulting stacked datasets). As disclosed above, a derived column 307 refers to a column that does not correspond to a native column of a dataset 305. A derived column 307 may be calculated in accordance with the source configuration 308 thereof. The source configuration 308 of a dependent derived column 307 may reference one or more other columns 307 (e.g., may reference source columns 307). The transform engine 160 may be configured to calculate derived columns 307 in accordance with the source configurations 308 thereof. The transform engine 160 may be configured to calculate dependent derived columns 307 for a result dataset 157 by use of one or more other column(s) of the result dataset 157 (or column(s) of another result dataset 157). As disclosed in further detail herein, the transform engine 160 may be configured to determine dependencies between columns 307 of the result datasets 157 (in accordance with the source configuration 307 of the columns to be added thereto). The transform engine 160 may be configured to implement the dataset-specific calculations, including calculations to derive respective dependent columns 307 of the results datasets 157, in accordance with the determined dependencies.

The transform engine 160 may be further configured to generate the output dataset 147 for the DAV component 140, which may comprise generating an empty and/or generic dataset having columns corresponding to the columns 307 (and/or column aliases 317) of the DAV component 140. The transform engine 307 may be further configured to include a UID column in the output dataset 147, as disclosed herein. The transform engine 307 may be further configured to populate the output dataset 147 with contents of the stacked dataset(s). Populating the output dataset 147 may comprise mapping column(s) of respective result dataset(s) 157 of the stacked dataset(s) to columns of the output datasets 147. The populating may comprise aliasing one or more columns of the stacked dataset(s) (e.g., may comprise mapping “native” columns 307 of the result datasets 157 and/or stacked dataset(s) to column aliases 317). The populating may comprise mapping required dimension columns of the stacked result dataset(s) 157 to aliases of the result dimensions columns. The transform engine 160 may be further configured to populate the UID column of the output dataset 147, such that the UID column represents a concatenation of the required dimension columns of the result datasets 147 mapped thereto, as disclosed above.

The transform engine 160 may be further configured to implement global operations on the output dataset 147 in a determined dependency order, which may comprise: re-aggregating the output dataset 147 by use the UID column (e.g., aggregate entries corresponding to same identifiers of the UID column), implementing average calculations pertaining to the output dataset 147, implementing filter operations pertaining to aggregated columns 307 of the output dataset 147, implementing sort operations on the output dataset 147, and/or the like.

The DAV engine 112 may further comprise a visualization engine 180, which may be configured to render the output dataset 147 (render a visualization 148 of the output dataset 147). The visualization engine 180 may be configured to render the output dataset 147 for display within a visualization component 480, as disclosed above. The visualization component 480 may comprise an extent control 482, which may provide for specifying the extent of the target 141 to be visualized therein. Modifications to the extent control 482 may result in modifications to the target dataset 147, which modifications may be implemented by the DAV engine 112, as disclosed above. By way of non-limiting example, the extent control 482 may specify an extent corresponding to a specified range of a “Date” category column 307 (e.g., dates from 2015 to 2016). The extent of the value parameter 142 may comprise the specified range (e.g., may extend beyond the specified range to enable minor changes without modifying the output dataset 147). Modifications to the extent control to specify a different ranges may require data not included in the current output dataset 147 (e.g., a modification to specify date range from 2004 to 2006). In response to such a modification (and/or in response to determining that the visualization 148 requires data not included in the current output dataset 147), the DAV engine 112 may be configured to modify the DAV component 140, and obtain updated output data 147. The modifications to the DAV component 140 may comprise modifying the extent of the category parameter 142 to include the specified extent (per the modification(s) made to the extent control 482). The DAV engine 112 may produce an updated output dataset 147 in accordance with the updated DAV component 140, which may include data corresponding to the modifications made to the extent control 482.

The visualization component 480 may be displayed in conjunction with other components, such as comprising for modifying parameters 142 of the DAV component 140 as illustrated in FIG. 4B (e.g., a category, value, series, filter, and/or sort components 442, 443, 444, 445, and/or 446). Modifications to one or more of the parameters 142 of the DAV component 140 may trigger the DAV engine 112 to update the DAV component 140 and/or produce a corresponding output dataset 147, as disclosed herein. For example, designating a different column 307 and/or aggregation the value parameter 142 may involve obtaining a different output dataset 147 corresponding to different column 307 and/or aggregation. Similar modifications involving similar changes to the output dataset 147 may be implemented in response to modifications of others of the parameters 142 of the DAV component 140.

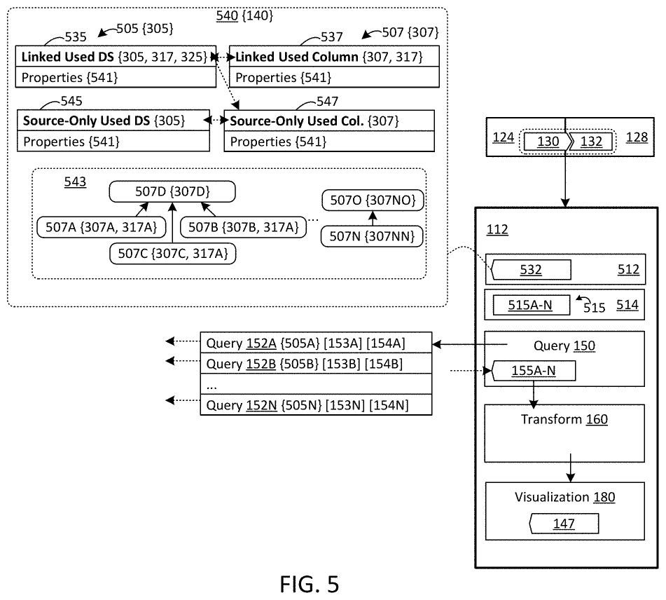

FIG. 5 illustrates further embodiments of a DAV engine 112, which may be configured to implement a DAV component 140, as disclosed herein. In the FIG. 5 embodiment, the DAV engine 112 may comprise a parser 512, which may be configured to parse and/or interpret the DAV component 140 and/or distributed data model 301. The parser 512 may be configured to parse data comprising the DAV component 140 (e.g., data structures, instructions, script, and/or the like). The parser 512 may be further configured to extract, interpret, and/or otherwise determine information pertaining to the configuration, parameters 142, and/or visualization 148 of the DAV component 140.

The parser 512 may be further configured to determine an implementation model 540 for the DAV component 140. The implementation model 540 may be maintained in memory, cache memory, cache storage, non-transitory storage, and/or the like. The implementation model 540 may comprise information pertaining to the DAV component 140, which may include, but is not limited to: used datasets 505, used columns 507, and/or the like. As disclosed above, a used dataset 505 of a DAV component 140 refers to a dataset 305 that is involved in the implementation of the DAV component 140. A used column 507 of a DAV component 140 refers to a column 307 that is involved in the implementation of the DAV component 140.

The used datasets 305 of a DAV component 140 may comprise datasets 305 linked to the target 141 of the DAV component 140 (datasets 305 having a same alias 315 as the target 141 of the DAV component 140). The used datasets 505 that are linked to the target 141 of the DAV component 140 may be represented as “target used datasets” or “linked used datasets” 535 within the implementation model 540. The “used columns” 507 of the DAV component 140 may comprise columns 307 referenced by parameters 142 of the DAV component 140 (and/or columns 307 linked thereto). Used columns 507 that are referenced by parameters 142 of the DAV component 140 (and/or linked such columns 307 by a column alias 317 and/or the like) may be represented as “target linked columns” or “linked used columns” 537 within the implementation model 540.

In some embodiments, a used column 507 of a DAV component 140 may be dependent on one or more other columns 307 (the used column 507 may correspond to a dependent column 307 to be calculated and/or derived from specified source columns 307, per the source configuration 308 thereof). The source column(s) 307 used to calculate and/or derive other used columns 507 of a DAV component 140, and the corresponding dataset(s) 305 thereof, may also be involved in the implementation of the DAV component 140 (may be used columns/datasets 507/507 of the DAV component 140). Columns 307 that are only used to calculate and/or derive other used column(s) 507 may be represented as “source-only used columns” 547 in the implementation model 540. Datasets 305 that only comprise source-only used columns 547 may be represented as “source-only used datasets” 545 in the implementation model 540.

Determining the linked used datasets 505 of a DAV component 140 may comprise determining whether the target 141 of the DAV component 140 references a linked dataset 305, a dataset alias 315, a distributed dataset 325, and/or the like, as disclosed herein. The datasets linked to the target 141 may be identified by, inter alia, identifying datasets 305 linked to the target dataset 305, dataset alias 315 and/or distributed dataset 325 within the distributed data model 130, as disclosed herein.

Determining the linked used columns 537 of a DAV component 150 may comprise parsing parameters 142 of the DAV component 140 to identify columns 307 referenced therein. Determining the linked used columns 537 may further comprise parsing the identified columns 307 to identify columns 307 linked thereto (e.g., may comprise identifying columns 307 of linked datasets 305 having the same name and/or column alias 317 as the identified columns 307). Identifying the used columns 507 of the DAV component 140 may further comprise parsing source configurations 308 of the used columns 507 to identify columns 307 referenced thereby (e.g., to identify source columns 307 of the used columns 307). Identifying the source-only used columns 547 may comprise identifying used columns 507 that are only used to calculate and/or derive other used columns 507. Identifying the source-only used datasets 545 may comprise identifying used datasets 505 that only comprise source-only used columns 547 (e.g., do not comprise any linked used columns 535).

The parser 512 may be further configured to assign properties 541 to respective used columns 507 and/or used datasets 505. In some embodiments, the parser 512 is configured to assign an “Aggregated Column” property 541A to one or more of the used columns 507. The parser 512 may assign the aggregated column property 541A to a used column 507 in response to determining that the column 307 thereof is used in an aggregation operation defined by the DAV component 140. The parser 512 may assign the aggregated column property 541A to a used column 507 in response to determining that the column 307 thereof is used in one or more of a value and aggregated series parameter 142 of the DAV component 140. The parser 512 may be further configured to assign a “required dimension” property 541B to one or more used columns 507. The parser 512 may assign the required dimension property 541B to a used column 507 in response to determining that the column 307 thereof is used in one of a category and non-aggregated series parameter 142 of the DAV component 140.

In some embodiments, the parser 512 is configured to assign a “dependent column” property 541C to one or more of the used columns 507. The parser 512 may assign the dependent column property 541C to a used column 507 in response to determining that the column 307 thereof comprises a dependent column 307. As disclosed herein, a dependent column 307 refers to a column 307 that is calculated and/or derived from one or more other columns 307 (e.g., a column 307 having a source configuration 308 that references one or more other columns 307). The parser 512 may assign the dependent column property 541C to a used column 507 in response to determining that the source configuration 308 of the column 307 references one or more other columns 307. The dependent column property 541C assigned to the used column 507 may be configured to identify the one or more used columns 507 on which the used column 507 depends. A column 307 used to calculate and/or derive a dependent column 307 may be referred to as a source column 307 of the dependent column 307. The parser 512 may be configured to assign a “Source Column” property 541D to a used column 507 in response to determining that the column 307 thereof comprises a source column 307 of one or more other used columns 507. The source column property 541D may be configured to identify the one or more used columns 507 that are dependent thereon. The parser 512 may be further configured to assign a “source only” property 541E to a used column 507 in response to determining that the column 307 thereof is only used as a source column 307 of one or more other used columns 507 (and/or may represent the used column 507 as a source only-used column 547, as disclosed above). The parser 512 may assign the source only property 541E to a used dataset 505 in response to determining that each used column 507 thereof comprises the source only property 541E (and/or may represent the used dataset 505 as a source only-used dataset 545, as disclosed above).

The parser 112 may be further configured to determine dependencies between used columns 507 of the implementation model 540 (column dependencies). The dependencies between used columns 507 may be indicated by properties 541C and/or 541D assigned to the used columns 507, as disclosed above. Alternatively, or in addition, the parser 112 may be configured to maintain dependency information pertaining to used columns 507 in a dependency property 541F of the used columns 507. The dependency property 541F of a used column 507 that corresponds to a native dataset column 307 may be unassigned, blank, and/or indicate that the used column 507 does not depend on other used columns 507. The dependency property 541F of a used column 507 that depends on one or more other used columns 507 may identify the one or more other used columns 507. The dependency property 541F of a used column 507 used to calculate and/or derive one or more other dependent used columns 507 may identify the one or more depended used columns 507 that depend thereon. Alternatively, or in addition, the DAV engine 112 may represent dependency information pertaining to the used columns 507 in a dependency model 533. The dependency model 543 may comprise any suitable means for representing dependency information including, but not limited to: a list, a table, a graph, a dependency graph, a directed graph, a directed acyclic graph (DAG), and/or the like. FIG. 5 illustrates an exemplary embodiment of a dependency model 543. In the FIG. 5 example, column 307D of used column 507D depends on column 307A (e.g., may specify column 307A in the source configuration 308 thereof). Column 307A may comprise a linked column 307A associated with column alias 317A. The DAV engine 112 may, therefore, determine that the used column 507D depends on used column 507A and the other used columns 507 linked thereto (used columns 507B and 507C). FIG. 5 further illustrates dependency information corresponding to the exemplary “Total seconds” column 307NO disclosed above in conjunction with FIG. 3J. The “Total seconds” column 307NO of dataset 305N (which may be a used dataset 505 of the DAV component 140 in this example), may be derived from the “Minutes” column 307NN and, as such, may depend thereon. Although particular embodiments and/or data structures for an implementation model 540 and/or dependency model 543 as described herein, the disclosure is not limited in this regard, and could be adapted to maintain information pertaining to the implementation of DAV component 140 using any suitable means (e.g., any suitable data structure, dependency structure, graph structure, and/or the like). As disclosed in further detail herein, the DAV platform 112 may leverage the implementation model 532 (and/or dependency information thereof) to order operations pertaining to the used columns 507 (e.g., order operations to prevent data hazards, cyclic dependencies, and/or the like).

The DAV engine 112 may further comprise a validator 514, which may be configured to validate the DAV component 140. Validating the DAV component 140 may comprise determining whether the DAV component 140 is suitable for and/or capable of being implemented by the DAV engine 112. Validating the DAV component 140 may comprise evaluating one or more validation rules 115. The validation rules 115 may define criteria for identifying valid DAV components 140 (e.g., distinguishing valid DAV components 140 from invalid DAV components 140). In the FIG. 5 embodiment, the validation rules 115 may include, but are not limited to: an aggregated column rule 115A, a required dimensions rule 115B, a column aggregation rule 115C, a non-aggregated series rule 115D, a sorted calculated column rule 115E, and so on, including a column dependency rule 115N. The aggregated column rule 115A may require that at least one used column 507 of the DAV component 140 correspond to an aggregated column (e.g., comprise at least one used column 507 having the aggregated column property 541A, as disclosed above). The required dimensions rule 115B may require that each linked used dataset 535 comprise each required dimension (e.g., include a linked used column 537 assigned a required dimension property 541B corresponding to each required dimension of the DAV component 140). The required dimensions rule 115B may be further configured to exclude used datasets 505 having the source only property 541E (e.g., exclude source-only used datasets 545 of the implementation model 540). The column aggregation rule 115C may require that aggregated columns (used columns 507 having the aggregated column property 541A) specifying an aggregation other than “Count” have a numeric data type. The non-aggregated series rule 115D may require that non-aggregated series parameter(s) 142 of the DAV component 140 reference only one aggregated column 307. The sorted calculated column rule 115E may require that sort parameters 142 pertaining to derived columns 307 be aggregated (e.g., require the used columns 507 thereof to have the aggregated column property 541A). The column dependency rule 115N may require that dependencies of used columns 507 be satisfied by other used columns 507 (e.g., do not depend on columns 307 that do not correspond a used columns 507 of the implementation model 540). The column dependency rule 115N may be further configured to verify that column dependencies are capable of being satisfied (e.g., do not require cyclical dependencies, and/or the like). In response to determining that the DAV component 140 (and/or implementation model 540 thereof) fails to satisfy one or more of the validation rules 115A-N, the DAV engine 112 may suspend further processing thereon. The DAV engine 112 may issue a notification indicating reasons(s) for the failure and/or suggested actions for correction (e.g., identify one required columns not defined in a specified used dataset 505). The notification may be displayed in an interface, such as the interface 124 and/or 128, as disclosed herein.

The query engine 150 may be configured to obtain result datasets 157 corresponding to each used dataset 505 of the implementation model 540. Obtaining the used result datasets 157 may comprise generating a plurality of queries 152, each query 152 corresponding to a respective one of the used datasets 505 (e.g., the query engine 150 may be configured to generate queries 152A-N corresponding to each used dataset 507A-N of the DAV component 140). The query engine 150 may generate the queries 152 for respective used datasets 505 by use of configuration data of the corresponding datasets 305 (e.g., the address, authentication credentials, driver, query template, and/or other information for accessing respective datasets 305 maintained within the distributed data model 130).

Each query 152 may be configured to return a respective result dataset 157 comprising column(s) required to produce the output dataset 147 as specified by the DAV component 140. Generating the queries 152 may comprise de-aliasing the queries 152, as disclosed herein. As disclosed above, using a dataset 305 assigned a particular alias 315 in the DAV component 140 may result in using each dataset 305 linked to the particular alias 315 (creating used datasets 505 corresponding to each dataset 305 linked to the particular alias 315). The query engine 150 may, therefore, be configured to generate a query 152 corresponding to each dataset 305 linked to the particular alias 152, which queries 152 may be referred to as linked queries 152. The query engine 150 may be configured to de-alias linked queries 152, such that the linked queries 152 generated for each linked used dataset 535 correspond to the source configuration 306 of the corresponding dataset 305 as opposed to the common dataset alias 315 assigned thereto. De-aliasing the linked queries 152 corresponding to a particular linked dataset 305 may, therefore, comprise replacing the alias 315 of the linked dataset 305 with a name and/or other identifier specified to the particular linked dataset 305.

The query engine 150 may be configured to determine query parameters 154 for each query 152. As used herein, a query parameter 154 refers to a parameter, argument, field, and/or other means for specifying one or more elements/columns of a source dataset 105, data store 104, DMS 102, and/or the like. The query parameters 154 determined for a query 152 generated for a particular used dataset 157 may specify the fields/columns of the corresponding source dataset 105 to include in the result dataset 157 returned therefrom. The query engine 150 may be configured to determine the column parameters 154 for a query 152 corresponding to a particular used dataset 505 based on, inter alia, the used columns 507 of the particular used dataset 505. The query parameters 154 determined for each used dataset 505 may include the fields/columns corresponding to the used columns 507 thereof. The query parameters 154 of a linked used dataset 535 may correspond to: parameters 142 of the DAV component 140 (e.g., correspond to the category, value, series, filter, and/or sort parameters 142 of the DAV component 140), and/or used columns 507 of the linked used dataset 535 used to calculate and/or derive other used columns 507 (if any). The query parameters 154 of source-only used datasets 545 may correspond to the source-only used columns 547 thereof. The query engine 150 may configure the query parameters 154 for each used dataset 505 to specify columns corresponding to each native used column 507 thereof. The query engine 150 may be further configured to de-alias column parameters 154 corresponding to used columns 507, which may comprise using the column name or other identifier specified in the source configuration 308 of the corresponding column 307 rather than the column alias 317 assigned thereto (if any). The column parameters 154 may omit columns 307 that do not correspond to used columns 507. The query engine 150 may be further configured to de-alias the queries 152 and/or query parameters 154 thereof, as disclosed herein, which may comprise replacing dataset aliases 315 and/or column aliases 317 with corresponding original, native dataset 305 and/or column 307 names, identifiers, and/or the like.

The query engine 150 may be further configured to determine one or more limit parameters 155 for the queries 152. As used herein, a “limit parameter” 155 refers to any suitable means for specifying an extent of a query 152 or, more specifically, means for specifying an extent of a result dataset 157 to be returned in response to the query 152. As disclosed above, the extent of a result dataset 157 returned in response to a query 152 refers to the number of entries therein and/or a range covered thereby (e.g., the range being defined in accordance with one or more dimensions of the dataset). A limit parameter 155 may limit the extent of a query 152 by, inter alia, specifying a particular range covered by the query 152, defining a granularity of the query, and or the like, as disclosed herein.

In some embodiments, the query engine 150 may be configured to determine limit parameters 155 for the queries 152 in accordance with the extent of the category parameter 142 of the DAV component 140. As disclosed above, the extent of the category parameter 142 may correspond to an extent required to power the visualization 148 of the DAV component 140 (may correspond to an extent selected by use of and extent control 482, as disclosed herein). The extent of the DAV component 140 may correspond to a relatively small subset of the full extent of the target 141 dataset(s) 305 of the DAV component 140 (and/or corresponding source datasets 105, data stores 104, DMS 102, and/or the like). The query engine 150 may be configured to set the extent 509 of the used datasets 505 in accordance with the required extent of the DAV component 140 and/or data visualization 135. In some embodiments, the query engine 150 may be configured to set the limit parameters 155 to be larger than the required extent of the data visualization 148, which may enable the target dataset 147 produced thereby to support modifications to the extent control 482 without implementing corresponding modifications to the target dataset 147.

In some embodiments, the query engine 150 may determine one or more limit parameters 155 based on aggregation operations pertaining of the DAV component 140. A limit parameter 155 of a query 152 may be adapted to implement one or more aggregation and/or grouping operations prior to returning the dataset 155. By way of example, a limit parameter 155 may correspond to a selected date granularity of a dimension column (e.g., a “Date” column 307). The limit parameter 154 may configure the data store 104 and/or DMS 102 to aggregate result datasets 157 in accordance with the specified granularity (e.g., aggregate the result datasets 157 in accordance with a dategrain such as “day,” “week,” “month,” “quarter,” “year,” and/or the like). In some embodiments, the query engine 150 may adapt limit parameters 155 for respective queries 152 to implement aggregation operations of the DAV component 140. By way of further non-limiting example, the value parameter 142 of the DAV component 140 may correspond to a SUM aggregation of the value column 307. The query engine 150 may determine a limit parameter 155 corresponding to the SUM aggregation, such that the SUM aggregation is implemented pre-query with the aggregation operation being implemented in the corresponding result datasets 157. The query engine 150 may adapt limit parameters 155 to implement any suitable aggregation operation including, but not limited to: SUM, MIN, MAX, AVE, Count, and/or the like. The query engine 150 may be configured to omit limit parameters 155 pertaining to global operations (e.g., operations that must be performed across each of the corresponding linked result datasets 157, such as AVE aggregations that must be performed across linked result datasets 157).

The limit parameters 155 may correspond to non-aggregated filter parameters 142 of the DAV component 140. The non-aggregated filter parameters 142 may be included in the limit parameters 155 of the queries 152, such that entries that do not satisfy the filter criterion thereof may be excluded from the corresponding result datasets 157 (such that the non-aggregated filter parameters 142 are implemented pre-query).

The query manager 150 may be further configured to run the generated queries 152 generated for respective used datasets 505 (e.g., queries 152A-N corresponding to used datasets 505A-N). The query manager 150 may be configured to direct the queries 152A-N to the used datasets 505A-N, which may comprise issuing the queries 152A-N to a source dataset 105, data store 104, DMS 102, and/or the like, in accordance with the source configuration of the corresponding datasets 305. The query manager 150 may be further configured to retrieve result datasets 155 in response to the queries 152 as disclosed herein (e.g., retrieve result datasets 155A-N).

The transform engine 160 may be configured to produce the target dataset 147 of the DAV component 140 by use of the result datasets 157 obtained by the query engine 150, as disclosed herein. The transform engine 160 may add a UID column to each result dataset 157 associated with a used linked dataset 535 (each linked result dataset 157). The UID column added to each linked result dataset 157 may comprise a concatenation of the required dimensions thereof. The transform engine 160 may be further configured to stack the linked result datasets 157. The stacking may comprise generating the UID column for the stacked result datasets 535 and re-aggregating the stacked linked result datasets 157 accordingly.

In response to the stacking, the transform engine 160 may be further configured implement dataset-specific operations pertaining to the stacked result datasets 157, which may comprise calculating derived used columns 507 of the implementation model 540, as disclosed herein. The derived used columns 507 may be calculated in accordance with the dependency model 543 (e.g., to ensure calculations are performed in order of dependency). In response to completing the dataset-specific operations, the transformation engine 160 may generate the output dataset 147 for the DAV component 140, which may comprise generating an empty and/or generic dataset having columns corresponding to the columns 307 (and/or column aliases 317) of the DAV component 140. The transform engine 160 may be further configured to include a UID column in the output dataset 147, as disclosed herein. The transform engine 160 may be further configured to populate the output dataset 147 with contents of the stacked linked result datasets 157. Populating the output dataset 147 may comprise mapping column(s) of respective linked result datasets 157 to columns of the output dataset 147. The populating may comprise aliasing one or more columns of the stacked dataset(s) (e.g., may comprise mapping “native” columns 307 of the stacked result datasets 157 to column aliases 317). The populating may comprise mapping required dimension columns of the stacked result dataset(s) 157 to aliases of the result dimensions columns. The transform engine 160 may be further configured to generate the UID column of the output dataset 147, such that the UID column represents a concatenation of the required dimension columns of the result datasets 147 mapped thereto, as disclosed above. The transform engine 160 may then aggregate data of the output dataset 147 based on the UID column.

The transform engine 160 may be further configured to implement global operations of the DAV component 140 in accordance with a pre-determined dependency order, which may comprise: a) implementing average calculations pertaining to the output dataset 147, b) implementing filter operations pertaining to aggregated columns 307 of the output dataset 147, c) implementing sort operations on the output dataset 147, d) implementing data limit rules pertaining to the output dataset 147, and so on. After completion of the global operations, the resulting output dataset 147 may be visualized by use of the visualization engine 180, as disclosed herein.

The DAV engine 112 may be further configured to monitor a state of the visualization (e.g., monitor the visualization state 149). The DAV engine 112 may be configured to detect modifications that correspond to modifications to the output dataset 147 and, in response, may produce an updated output dataset 147 in accordance with the modified DAV component 140, as disclosed herein.

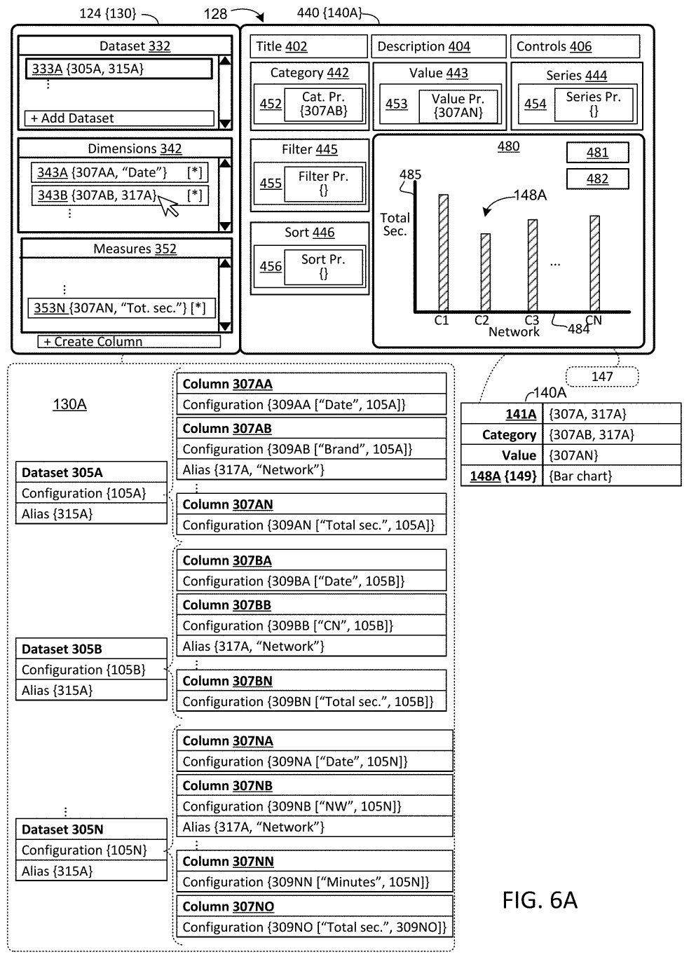

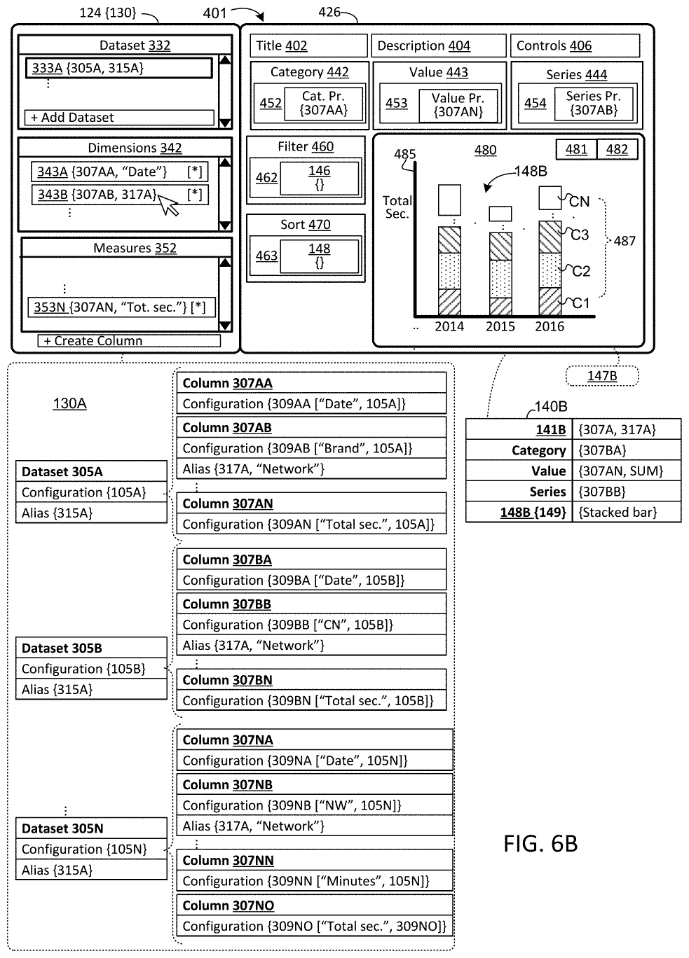

FIG. 6A illustrates further embodiments of systems and methods for developing, modifying, and/or implementing DAV components 140, as disclosed herein. In the FIG. 6A embodiment, the interface 124 components may correspond to the distributed data model 130A, as illustrated in FIG. 3J. As shown in FIG. 6A, the distributed data model 130A may comprise datasets 305A-N, which may correspond to respective source datasets 105A-N. The datasets 305A-N may have a same alias 315A (“Portal Data”) and, as such, the datasets 305A-N may comprise linked datasets 305A-N (e.g., the datasets 305A-N may be linked to the dataset alias 315A). The commonly named “Date” and “Total seconds” columns 307 of the linked datasets 305A-N may comprise linked columns of the linked datasets 305A-N (e.g., may comprise linked columns spanning datasets 305A-N). The “Total seconds” column 307NO may comprise a calculated column, which may be derived from the “Minutes” column 307NN, as disclosed herein. The “Brand,” “CN,” and “NW” columns 307AB, BB, and NB may be linked by use of the “Network” column alias 317A, as disclosed herein (e.g., may comprise linked columns spanning datasets 305A-N).

The dataset control 332 may be populated with entries 333A-N corresponding to one or more of the linked datasets 305A-N. In the FIG. 6A embodiment, the dataset control 332 includes a dataset component 333A corresponding to linked dataset 305A (and may omit dataset components 333 corresponding to datasets 305B-N). In response to selection of the dataset component 333A corresponding to dataset 305A, the interface 124 may update the components thereof to display information pertaining to the columns 307 thereof. The dimensions component 342 may comprise column components 343 corresponding to the dimension columns 307 of dataset 305A (columns 307AA-AB), and the measures component 352 may comprise column components 353 corresponding to measure columns 307 of dataset 305A (e.g., column 307AN). The target 141A of the DAV component 140A may, therefore, comprise the linked dataset 307A (and/or the dataset alias 315A). The DAV component 140A may, therefore, correspond to the datasets 305 linked to the alias 315A, including datasets 305A-N, as disclosed herein.

The components 440 may provide for defining a DAV component 140A, comprising a data visualization 148A similar to the visualization 248A of the first, conventional distributed analytics 240A. As illustrated in FIG. 6A, the category component 442 may designate the “Brand” column 307AB of dataset 305A for use in the category parameter 142 of the DAV component 140A (and/or may define properties thereof). The column 307AB may be associated with the “Network” alias 317A and, as such, the category parameter 142 of the DAV component 140A may comprise linked columns 307 associated with the column alias 317A (e.g., columns 307AB-NB, as disclosed herein). The value component 443 may designate the “Total seconds” column 307AN of dataset 305A for use in the value parameter 142 of the DAV component 140A (and/or define properties thereof). The “Total seconds” column 307AN may be linked to columns 307BN and 307BO by the “Total seconds” column name. The series, filter, and sort columns 307 of the DAV component 140A may be unassigned (the DAV component 140A may not comprise series, filter, and/or sort columns 307).

The visualization component 148A may define a bar chart visualization. As illustrated in FIG. 6A, the dimension axis 484 of the visualization component 148A may correspond to the “Network” column alias 317A of the value column 307AB (per the category parameter 142 of the DAV component 140A), and the value axis 485 may correspond to the “Total seconds” linked column 307AN. The extent of the visualization 148A may correspond to extent specified by use of, inter alia, the extent control 482 (and/or category properties component 452).

Implementing the DAV component 140A may comprise identifying the linked used datasets 535 thereof, which may include linked used datasets 535A-N corresponding to datasets 305A-N linked to alias 315A of the target dataset 305A, respectively. Implementing the DAV component 140A may further comprise identifying the linked used columns 537 thereof, which may comprise used columns 537 corresponding to columns 307AB-AN (linked to the “Network” column alias 317A of column 307AB) and linked used columns 537 corresponding to columns 307AN-NO (linked to the “Total seconds” column 307AN). Implementing the DAV component 140A may further comprise determining that the “Total seconds” column 307NO is dependent on the “Minutes” column 307NN (in response to determining that the source configuration 308NO thereof specifies that the “Total seconds” column 307NO is to be derived from the “Minutes” column 307NN). The “Minutes” column 307NN may comprise a source-only column 547 of the linked used dataset 535 corresponding to dataset 305N.

Implementing the DAV component 140A may further comprise the query engine 150 generating a plurality of queries 152A-N, each query 152A-N corresponding to a respective one of the linked used datasets 535A-N. Generating the queries 152A-N may comprise de-aliasing the queries 152A-N, such that the query 152A references source dataset 105A (as opposed to the dataset alias 315A), query 152B references source dataset 105B, and so on, with query 152N referencing source dataset 105N. The query engine 150 may be further configured to determine query parameters 154 for each query 152A-N. Determining the query parameters 154A-N for respective queries 152A-N may comprise specifying native columns 307 corresponding to each of the used columns 507 thereof (e.g., de-aliasing the used columns 307 of respective used datasets 507). The query parameters 154A may specify the “Brand” and “Total seconds” columns of source dataset 105A, the query parameters 154B may specify the “CN” and “Total seconds” columns of source dataset 105B, and so on. The query parameters 154N may specify the “NW” and “Minutes” columns of source dataset 105N (and may omit the non-native, derived “Total seconds” column 307). The query engine 152 may be further configured to determine limit parameters 155 for the queries 152, as disclosed herein. The limit parameters 155 may correspond to one or more of the extent of the category parameter 142 (and/or extent control 482), an aggregation operation pertaining to the DAV component 140A, filter parameters 142 of the DAV component 140A, and/or the like. In the FIG. 6A embodiment, the query engine 150 may incorporate the SUM aggregation into the query parameters, such that columns 307 corresponding to the SUM aggregation are aggregated pre-query.

The query engine 150 may be further configured to issue the queries 152A-N to the respective source datasets 105A-N, data stores 104A-N, and/or DMS 102A-N, as disclosed herein. The result datasets 157A-N may correspond to the native columns 307 of the linked datasets 305A-N (e.g., may comprise “Brand,” “CN,” and “NW” columns as opposed to the “Network” column alias, with result dataset 157N further comprising a “Minutes” column for use in deriving the dependent “Total seconds” column 307 therefrom). The transform engine 160 may generate an output dataset 147A for the DAV component 140A by use of result datasets 157A-N returned in response to the queries 152A-N. The transform engine 160 may be configured to: add a UID column to the result datasets 157A-N, stack the result datasets 157A-N, aggregate the result datasets 157A-N by use of the UID column, and so on. The transform engine 160 may be configured to implement dataset-specific operations, which may comprise calculating the “Total seconds” column of the result dataset 157N from the “Minutes” column thereof. In response to completing the dataset-specific calculations, the transform engine 160 may be configured to populate the UID column of the stacked datasets 157, as disclosed herein.

The transformation engine 160 may generate the output dataset 147A for the DAV component 140, which may comprise generating an empty and/or generic dataset having columns corresponding to the “Network” column alias 317A and the “Total seconds” linked column 307AB. The transform engine 160 may be further configured to include a UID column in the output dataset 147A, as disclosed herein. The transform engine 160 may be further configured to populate the output dataset 147A with contents of the stacked linked result datasets 157A-N. Populating the output dataset 147 may comprise mapping column(s) of respective stacked result datasets 157a-N to columns of the output dataset 147. The populating may comprise aliasing one or more columns of the stacked result dataset 157A-N to columns of the output dataset 147A (e.g., may comprise mapping “Brand,” “CN,” and “NW” columns 307AB-NB to the “Network” column of the output dataset 147A). The transform engine 160 may be further configured to generate the UID column of the output dataset 147A, such that the UID column represents a concatenation of the required dimension columns of the result datasets 147 mapped thereto, as disclosed above. The transform engine 160 may then aggregate data of the output dataset 147A based on the UID column, which may comprise implementing a SUM aggregation across the “Total seconds” columns of each stacked result dataset 157A-N.

The transform engine 160 may be further configured to implement global operations of the DAV component 140 in accordance with a pre-determined dependency order, which may comprise: a) implementing average calculations pertaining to the output dataset 147A, b) implementing filter operations pertaining to aggregated columns 307 of the output dataset 147A, c) implementing sort operations on the output dataset 147A, d) implementing data limit rules pertaining to the output dataset 147A, and so on. After completion of the global operations, the resulting output dataset 147A may be visualized by use of the visualization engine 180, as illustrated in FIG. 6A.

FIG. 6B illustrates further embodiments of interfaces 128 for developing, modifying, and/or implementing DAV components 140, as disclosed herein. In the FIG. 6B embodiment, the interface 124 components may correspond to the distributed data model 130A, as illustrated in FIG. 3J, and disclosed above. The dataset control 332 may be populated with entries 333A-N corresponding to one or more of the linked datasets 305A-N. In the FIG. 6B embodiment, the dataset control 332 includes a dataset component 333A corresponding to linked dataset 305A, the dimensions component 342 may comprise column components 343 corresponding to the dimension columns 307 of dataset 305A (columns 307AA-AB), and the measures component 352 may comprise column components 353 corresponding to measure columns 307 of dataset 305A (e.g., column 307AN). The target 141B of the DAV component 140B may, therefore, comprise the linked dataset 307A (and/or the dataset alias 315A). The DAV component 140B may, therefore, correspond to the datasets 305 linked to the alias 315A, including datasets 305A-N, as disclosed herein.

The components 440 may provide for defining parameters of the DAV component 140B, comprising a data visualization 148B similar to the visualization 248B of the second, conventional distributed analytics 240B. As illustrated in FIG. 6B, the category component 442 may designate the “Date” column 307AA of dataset 305A for use in the category parameter 142 of the DAV component 140B (and/or may define properties thereof). The value component 443 may designate the “Total seconds” column 307AN of dataset 305A for use in the value parameter 142 of the DAV component 140B (and/or define properties thereof). The “Total seconds” column 307AN may be linked to columns 307BN and 307BO by the “Total seconds” column name. The series component 444 may designate the “Brand” column 307AB as a non-aggregated series parameter 142 of the DAV component 140B. The column 307AB may be associated with the “Network” alias 317A and, as such, the category parameter 142 of the DAV component 140A may comprise linked columns 307 associated with the column alias 317A (e.g., columns 307AB-NB, as disclosed herein). The filter and sort columns 307 of the DAV component 140B may be unassigned (the DAV component 140A may not comprise series, filter, and/or sort columns 307).

The visualization component 148B may define a stacked bar chart visualization. As illustrated in FIG. 6B, the dimension axis 484 of the visualization component 148B may correspond to the “Date” linked column 307AA (per the category parameter 142 of the DAV component 140A), the value axis 485 may correspond to the “Total seconds” linked column 307AN, and the series elements 487 may correspond to the “Network” column alias 317A of the series column 307AB. The extent of the visualization 148A may correspond to extent specified by use of, inter alia, the extent control 482 (and/or category properties component 452).

Implementing the DAV component 140B may comprise identifying the linked used datasets 535 thereof, as disclosed above (e.g., linked used datasets 535A-N corresponding to datasets 305A-N linked to alias 315A of the target dataset 305A, respectively). Implementing the DAV component 140A may further comprise identifying the linked used columns 537, which may comprise used columns 537 corresponding to columns 307AA-NA (which may be linked in accordance with the “Date” column names thereof), linked used columns 537 corresponding to columns 307AN-NO (linked to the “Total seconds” column 307AN), and linked used columns 307AB-NB linked to the “Network” column alias 317A. Implementing the DAV component 140A may further comprise determining that the “Total seconds” column 307NO is dependent on the “Minutes” column 307NN of dataset 305N (in response to determining that the source configuration 308NO thereof specifies that the “Total seconds” column 307NO is to be derived from the “Minutes” column 307NN). The “Minutes” column 307NN may comprise a source-only column 547 of the linked used dataset 535 corresponding to dataset 305N.

Implementing the DAV component 140A may further comprise the query engine 150 generating a plurality of queries 152A-N, each query 152A-N corresponding to a respective one of the linked used datasets 535A-N, as disclosed above. The query engine 150 may be further configured to determine query parameters 154 for each query 152A-N. Determining the query parameters 154A-N for respective queries 152A-N may comprise specifying native columns 307 corresponding to each of the used columns 507 thereof (e.g., de-aliasing the used columns 307 of respective used datasets 507). The query parameters 154A may specify the “Date,” “Total seconds,” and “Brand” columns of source dataset 105A, the query parameters 154B may specify the “Date,” “CN” and “Total seconds” columns of source dataset 105B, and so on. The query parameters 154N may specify the “Date,” “NW” and “Minutes” columns of source dataset 105N (and may omit the non-native, derived “Total seconds” column 307). The query parameters 154A-N may specify the respective “Brand,” “CN,” and “NW” columns as “groupby” parameters of the respective queries 152A-N. The query engine 152 may be further configured to determine limit parameters 155 for the queries 152, as disclosed herein. The limit parameters 155 may correspond to one or more of the extent of the category parameter 142 (and/or extent control 482), an aggregation operation pertaining to the DAV component 140A, filter parameters 142 of the DAV component 140A, and/or the like. In the FIG. 6B embodiment, the query engine 150 may correspond to a specified range and/or granularity of the “Date” value column of the DAV component 140B, the range may correspond to years 2014-2016 and may specify a dategrain of “Year.” The limit parameters 155 may, therefore, include a “year” dategrain and/or limit the extent of the queries 152A-N to years 2014-2016.

The query engine 150 may be further configured to issue the queries 152A-N to the respective source datasets 105A-N, data stores 104A-N, and/or DMS 102A-N, as disclosed herein. The result datasets 157A-N may correspond to the native columns 307 of the linked datasets 305A-N (e.g., may comprise “Brand,” “CN,” and “NW” columns as opposed to the “Network” column alias, with result dataset 157N further comprising a “Minutes” column for use in deriving the dependent “Total seconds” column 307 therefrom). The transform engine 160 may generate an output dataset 147G for the DAV component 140A by use of result datasets 157A-N returned in response to the queries 152A-N. The transform engine 160 may be configured to: add a UID column to the result datasets 157A-N, stack the result datasets 157A-N, aggregate the result datasets 157A-N by use of the UID column, and so on. The transform engine 160 may be configured to implement dataset-specific operations, which may comprise calculating the “Total seconds” column of the result dataset 157N from the “Minutes” column thereof. In response to completing the dataset-specific calculations, the transform engine 160 may be configured to populate the UID column of the stacked datasets 157, as disclosed herein.

The transformation engine 160 may generate the output dataset 147B for the DAV component 140, which may comprise generating an empty and/or generic dataset having columns corresponding to the “Network” column alias 317A and the “Total seconds” linked column 307AB. The transform engine 160 may be further configured to include a UID column in the output dataset 147A, as disclosed herein. The transform engine 160 may be further configured to populate the output dataset 147B with contents of the stacked linked result datasets 157A-N. Populating the output dataset 147 may comprise mapping column(s) of respective stacked result datasets 157a-N to columns of the output dataset 147. The populating may comprise aliasing one or more columns of the stacked result dataset 157A-N to columns of the output dataset 147A (e.g., may comprise mapping “Brand,” “CN,” and “NW” columns 307AB-NB to the “Network” column of the output dataset 147B). The transform engine 160 may be further configured to generate the UID column of the output dataset 147B, such that the UID column represents a concatenation of the required dimension columns of the result datasets 147 mapped thereto, as disclosed above. The transform engine 160 may then aggregate data of the output dataset 147B based on the UID column, which may comprise implementing a SUM aggregation across the “Total seconds” columns of each stacked result dataset 157A-N grouped by the “Network” series column.

The transform engine 160 may be further configured to implement global operations of the DAV component 140 in accordance with a pre-determined dependency order, which may comprise: a) implementing average calculations pertaining to the output dataset 147B, b) implementing filter operations pertaining to aggregated columns 307 of the output dataset 147B, c) implementing sort operations on the output dataset 147B, d) implementing data limit rules pertaining to the output dataset 147B, and so on. After completion of the global operations, the resulting output dataset 147B may be visualized by use of the visualization engine 180, as illustrated in FIG. 6B.

The distributed data model 130 disclosed herein may be further configured to facilitate development of data analytics and/or visualizations by end users. Datasets 305 of the distributed data model 130, including derived columns 307 thereof, may be available for selection by end users for use in developing and/or modifying DAV components 140. As disclosed herein, a dataset 305 may comprise derived columns 307 which may not exist in the native source datasets 105 corresponding thereto. The derived columns 307 may enable end users to implement DAV components 140 that could not be implemented without such derived columns 307. By way of non-limiting example, a group of source datasets 105X-Z may comprise account metrics pertaining to an organization, each dataset comprising a “Date” column, “Sales” column, and region-specific “L Code” column. The “L Code” columns of each source dataset 105X-Z comprise different identifiers, which may not correspond to the identifiers of others of the source datasets 105X-Z. Identifiers of the source datasets 105X-Z may be mapped to a common set of report codes by respective mapping datasets 105T-V.

It may be useful to develop analytics pertaining to the source datasets 105X-Z (e.g., respective report codes), but it may be difficult to do so due to, inter alia, the use of different identifiers therein. The distributed data model 130 may be extended to include datasets 305X-Z, each corresponding to a respective source dataset 105X-Z. The datasets 305X-Z may include a “Report Code” column, which may be derived from the region-specific report codes thereof. The column source of the “Report Code” columns may comprise a lookup operation to insert the report code corresponding to respective region-specific identifier of the “L Code” column therein. The report code columns 307 may be selectable within the interfaces disclosed herein (e.g., interfaces 126, 128, and/or 440, which may enable end users to develop DAV components 140 utilizing the non-native “Report Code” columns 307 defined therein). The derived “Report Code” columns 307 of the datasets 305X-Z may be created by use of the create column control 339 of the interface 124, as disclosed herein.

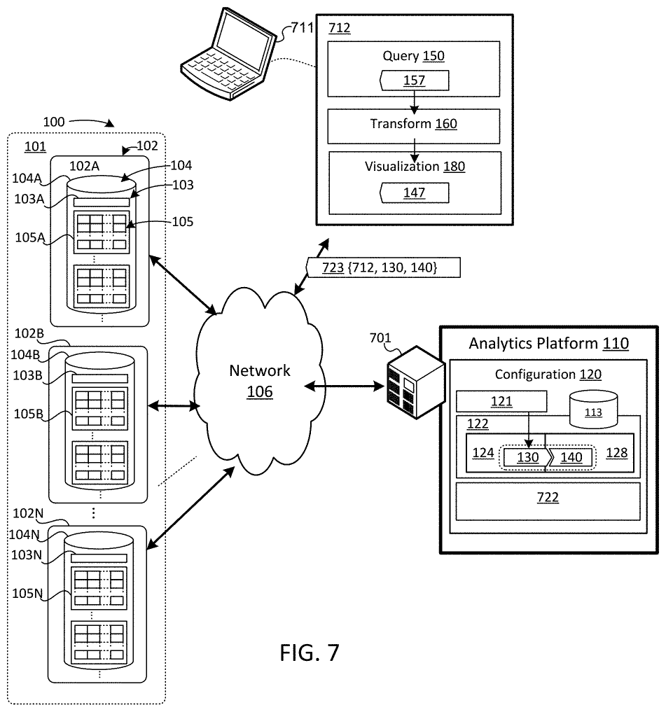

FIG. 7 depicts another embodiment of a system 100 comprising an analytics platform 110 configured to, inter alia, efficiently implement data analytics pertaining to distributed data. In the FIG. 7 embodiment, portions of the analytics platform 110 may be implemented on a server computing device 701. The server computing device 701 may be configured to implement the configuration manager 120 of the analytics platform 110 (e.g., may be configured to maintain the distributed data model 130, DAV components 140, and/or the like). The analytics platform 110 may further comprise one or more of the source datasets 105, data stores 104, DMS 102, and/or the like. Alternatively, the server computing device 701 may be communicatively coupled thereto (as illustrated in FIG. 7). The analytics platform 110 may further comprise a client interface 722, which may be configured to provide for client access to the analytics platform 110. The client interface 722 may be configured to serve interfaces to the client computing devices, such as client computing device 711. The interfaces may include, but are not limited to interfaces 124, 128, and/or 440, as disclosed herein. The client interface 722 may be further configured to provide computer-readable code 723 to client computing devices 711, which may be configured to cause the client computing devices 711 to implement a client DAV engine 712. The computer-readable code 723 may comprise a library, which may comprise information pertaining to the distributed data model 130, DAV components 140, and/or the like, as disclosed herein. The library 723 may further comprise code for implementing the client DAV engine 712. The client DAV engine 712 may be configured to implement DAV components 140, as disclosed herein.

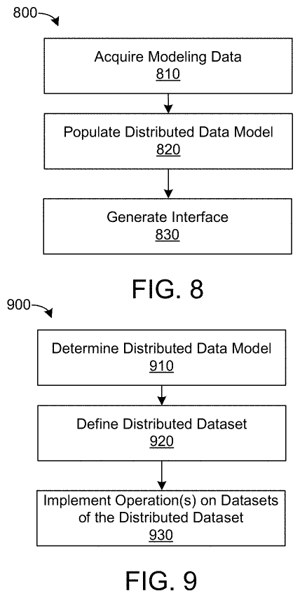

FIG. 8 is a flow diagram 800 of one embodiment of a method 800 for managing a distributed data model 130, as disclosed herein. Step 810 may comprise acquiring modeling data pertaining to data maintained in a distributed architecture, as disclosed herein. Step 810 may be performed by a modeler 123 in response to receiving initial configuration data. Step 820 may comprise populating a distributed data model 130 with the acquired modeling data, as disclosed herein. Step 830 may comprise generating an interface for displaying, modifying, and/or otherwise managing the distributed data model 130, as disclosed herein (e.g., generating interface 124).

FIG. 9 is a flow diagram 900 of another embodiment of a method 900 for managing a distributed data model 130, as disclosed herein. Step 910 may comprise determining a distributed data model 130 corresponding to data maintained in a distributed architecture 101, as disclosed herein. Step 920 may comprise defining a distributed dataset that spans a plurality of source datasets 105 of the distributed data model 130. Step 920 may comprise assigning an alias to one or more datasets 305 of the distributed data model, creating a distributed dataset 325, and/or the like. Step 920 may further comprise defining one or more derived columns 307 of one or more datasets 305, as disclosed herein. Step 930 may comprise implementing operation(s) pertaining to a specified dataset 305 of the distributed datasets 305, which may comprise implementing the operation(s) on each dataset linked to the distributed dataset (and/or alias 315 thereof), as disclosed herein.

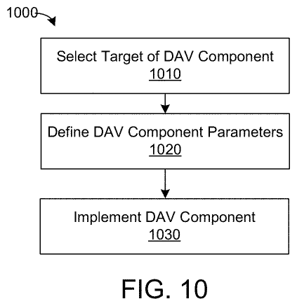

FIG. 10 is a flow diagram of another embodiment of a method 1000 for managing distributed data analytics and/or visualizations. Step 1010 may comprise selecting a target of a DAV component 140, as disclosed herein. Step 1010 may comprise selecting one or more of a linked dataset 305, a dataset alias 315, and/or a distributed dataset 325, as disclosed herein. Step 1020 may comprise defining one or more parameters 142 of the DAV component 140, including, but not limited to: a category, value, series, filter, and/or sort parameters, as disclosed herein. Step 1030 may comprise implementing the DAV component 140, as disclosed herein.

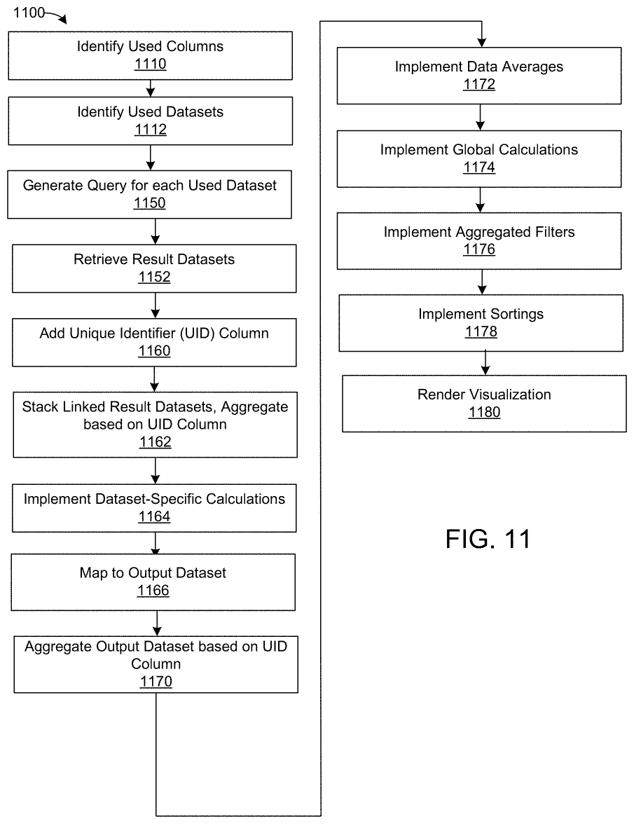

FIG. 11 is a flow diagram of one embodiment of a method 1100 for implementing a DAV component 140, as disclosed herein. Step 1110 may comprise determining the used columns 507 of the DAV component 140, as disclosed herein. Step 1120 may comprise determining the used datasets 505 of the DAV component 140, as disclosed herein. Steps 1110 and 1120 may comprise determining an implementation model 540 corresponding to the DAV component 140, which may comprise determining used linked datasets 535. source-only datasets 545, linked used columns 537, source-only linked columns 547, and so on, as disclosed herein. Steps 1110 and 1120 may further comprise determining dependencies of one or more of the used columns 507, as disclosed herein.

Step 1150 may comprise generating queries 152 for each used dataset 505, as disclosed herein. Step 1150 may further comprise determining query parameters 154 and/or limit parameters 155 for the queries 152. Step 1152 may comprise retrieving result datasets 157 corresponding to each query 152 (each used dataset 505), as disclosed herein

Step 1160 may comprise adding a UID column to each result dataset 157 (and/or each result dataset 157 corresponding to a linked used dataset 535). Step 1162 may comprise stacking linked result datasets 157, as disclosed herein. Step 1162 may further comprise aggregating the stacked linked result datasets 157 by use of the UID column(s) thereof. Step 1164 may comprise implementing dataset-specific calculations pertaining to the stacked linked result datasets 157 (in accordance with determined column dependencies), as disclosed herein. Step 1164 may further comprise populating the UID columns of the stacked linked result datasets 157.

Step 1166 may comprise mapping the stacked result datasets 157 to the output dataset 147 for the DAV component 140. Step 1166 may comprise generating an empty, generic output data 147. Step 1166 may further comprise mapping columns of the stacked linked result datasets 157 to columns of the output dataset 147, as disclosed herein. Step 1170 may comprise aggregating the output dataset 147 by use of the UID column thereof. Steps 1172-1178 may comprise implementing global operations on the output dataset 147, including, implementing data average operations at step 1172, implementing global calculations at step 1174, implementing aggregated filters at step 1176, and so on, including implementing sortings at step 1178. Step 1180 may comprise rendering a visualization of the output dataset 147 in accordance with the visualization component 148 thereof, as disclosed herein.

This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

1. A method for implementing a data visualization pertaining to data spanning a plurality of data stores, comprising:
providing computer-readable code to a client computing device, the computer-readable code configured to cause the client computing device to perform operations, comprising:
acquiring a plurality of datasets, each dataset corresponding to a respective one of a plurality of data stores, the acquiring comprising:
determining a query limit parameter, and
generating a plurality of queries, each query corresponding to a respective one of the plurality of data stores and comprising a limit parameter corresponding to the determined query limit parameter;
producing an output dataset comprising result data retrieved in response to the queries, comprising:
adding a unique identifier column to a plurality of the result datasets,
forming a stacked dataset comprising a plurality of the result datasets by use of the unique identifier column, and
mapping columns of the stacked dataset to an output dataset; and
rendering a visualization of the output dataset for display to a user on a display of the client computing device.

2. The method of claim 1, the method further comprising determining the query limit parameter based on a selected range of the rendered visualization of the output dataset.

3. The method of claim 1, further comprising linking a plurality of datasets to a dataset alias, wherein the plurality of datasets comprise datasets associated with the dataset alias.

4. The method of claim 3, further comprising linking columns of each dataset associated with the dataset, such that each linked column of a first one of the plurality of datasets is linked to corresponding columns of each of the others of the plurality of datasets.

5. A non-transitory computer-readable storage medium comprising instructions configured to cause a computing device to perform operations, comprising:
acquiring a plurality of datasets, each dataset corresponding to a respective one of a plurality of data stores, the acquiring comprising:
determining a query limit parameter, and
generating a plurality of queries, each query corresponding to a respective one of the plurality of data stores and comprising a limit parameter corresponding to the determined query limit parameter;
producing an output dataset comprising result data retrieved in response to the queries, comprising:
adding a unique identifier column to a plurality of the result datasets,
forming a stacked dataset comprising a plurality of the result datasets by use of the unique identifier column, and
mapping columns of the stacked dataset to an output dataset; and
rendering a visualization of the output dataset for display to a user on a display of the client computing device.

6. The computer-readable storage medium of claim 5, the operations further comprising determining the query limit parameter based on a selected range of the rendered visualization of the output dataset.

7. The computer-readable storage medium of claim 5, the operations further comprising linking a plurality of datasets to a dataset alias, wherein the plurality of datasets comprise datasets associated with the dataset alias.

8. The computer-readable storage medium of claim 7, the operations further comprising linking columns of each dataset associated with the dataset, such that each linked column of a first one of the plurality of datasets is linked to corresponding columns of each of the others of the plurality of datasets.

9. A system, comprising:
a distributed data visualization platform comprising a distributed data model, the distributed data model comprising a plurality of datasets linked to a same alias;
a visualization engine configured to:
acquire a plurality of datasets, each dataset corresponding to a respective one of a plurality of datasets linked to the same alias, the acquiring comprising:
determining a query limit parameter, and
generating a plurality of queries, each query corresponding to a respective one of the plurality of the datasets and comprising a limit parameter corresponding to the determined query limit parameter;
produce an output dataset comprising result data retrieved in response to the queries, by:
adding a unique identifier column to a plurality of the result datasets,
forming a stacked dataset comprising a plurality of the result datasets by use of the unique identifier column, and
mapping columns of the stacked dataset to an output dataset; and
a visualization engine configured to render a visualization of the output dataset for display to a user on a display of the client computing device.
